(19) United States
(12) Patent Application Publication
(10) Pub. No.: US 2018/0127554 A1
(43) Pub. Date: May 10, 2018

(54) BIODEGRADABLE POLYMER-BASED BIOCOMPOSITES WITH TAILORED PROPERTIES AND METHOD OF MAKING THOSE

(71) Applicant: University of Guelph, Guelph (CA)

(72) Inventors: Amar Kumar MOHANTY, Guelph (CA); Manjusri MISRA, Guelph (CA); Nima ZARRINBAKHSH, Guelph (CA); Rajendran MUTHURAJ, Guelph (CA); Tao WANG, Guelph (CA); Arturo RODRIGUEZ-URIBE, Guelph (CA); Singaravelu VIVEKANANDHAN, Salem (IN)

(21) Appl. No.: 15/555,889

(22) PCT Filed: Mar. 4, 2016
(86) PCT No.: PCT/CA2016/050237

§ 371 Date: Sep. 5, 2017

Related U.S. Application Data
(60) Provisional application No. 62/128,736, filed on Mar. 5, 2015.

(51) Int. Cl. C08J 3/20; C08K 11/00; C08J 5/04; C08K 3/00; C08K 5/00; C08K 5/103; C08L 101/06; C08L 101/16; C08L 67/00

(52) U.S. Cl. CPC C08J 3/201; C08L 2201/06; C08J 5/045; C08K 3/0033; C08K 5/0016; C08K 5/103; C08L 101/06; C08L 101/16; C08L 67/00; C08J 2300/16; C08J 2367/02; C08J 2367/04; C08J 2467/02; C08J 2467/04; C08K 11/005

(57) ABSTRACT

A biodegradable composite including: (a) a polymeric matrix having a biodegradable polymer; (b) a filler; and (c) an anhydride grafted compatibilizer including one or more biodegradable polymers modified with an anhydride group. The composite may also include (d) polymer additives such as polymer chain extenders or plasticizers. An in situ method of manufacturing the biodegradable composite of the present invention, including the steps of: (a) melting one or more biodegradable polymers in the presence of a functional monomer and a free radical initiator to form a mixture; and (b) adding a filler and polymer additives to the mixture thereby manufacturing the biodegradable composite. A method of manufacturing a biodegradable polymer including (a) synthesizing a compatibilizer by (i) mixing a free radical initiator and a functional monomer, (ii) melting one or more biodegradable polymers to form a melt, and (iii) combining the product of step (i) and the melt of step (ii) thereby synthesizing the compatibilizer; and (b) mixing the compatibilizer of step (a), with a matrix of one or more biodegradable polymers and a filler and polymer additives, thereby manufacturing the biodegradable or compostable composite.

### FIELD OF THE INVENTION

The present invention relates to biodegradable and compostable polymer-based biocomposites with tailored properties and method of making those.

### BACKGROUND OF THE INVENTION

The growing global population has raised concerns about fulfilling the energy demand in near future. Our current dependence on fossil fuel based polymers is not sustainable due to depleting fossil fuel resources and volatile prices. This is one of the key motivations for seeking renewable resources of materials, chemicals and energy. At the same time, waste management is a critical issue tied with growing municipal landfills as well as the carbon footprint of the growing industry. A promising approach could be the use of wastes/co-products/by-products from different industries and turn them into applied materials with end-of-life biodegradability.

Renewable resource materials such as a biobased polymers and natural fibers and biomasses are practical candidates to substitute petro-based polymers and synthetic fibers in many areas. More specifically, substituting petro-based polymers and composites, completely or partially, by a combination of biobased polymers and natural fibers from agricultural residues and/or wastes/co-products/by-products from different industries in a whole material that exhibits end-of-life biodegradability and compostability addresses both the global concerns discussed previously; the dependence on petroleum and waste management.

Natural fibers from wastes/co-products/by-products from different industries that can be used in composite materials include, but are not limited to, (i) waste/by-products from coffee/tea farming and processing industries (including but not limited to coffee chaff, coffee husk, coffee ground, spent coffee, spent tea leaves, etc.), and/or (ii) perennial grasses (including but not limited to miscanthus, switchgrass, bamboo) and agricultural residues (including but not limited to agricultural straws, stalks, leaves, etc.), and/or (iii) co-products of grain-based ethanol industries (grain-based fibrous and/or proteineous materials including but not limited to, distillers' dried grains (DDG), distillers' dried grains with solubles (DDGS), kernel fibre, gluten meals, gluten feeds), and/or (iv) inorganic fillers (including but not limited to talc, clay, calcium carbonate, wollastonite, barium sulfate).

The first generation bioethanol, which is mostly corn-based ethanol, is projected to stay as the main contributor to bioethanol production in North America [1]. In 2011, 56.26 billion liters of ethanol was produced from coarse grains (mainly corn) and it is projected that this value will reach 68.19 billion liters in 2020; i.e. 21% increase [1].

In a dry-mill ethanol plant, the starch portion of corn is fermented into alcohol, leaving non-starchy components or fermentation solids as the co-product. These components or fermentation solids, which include protein, fiber, fat and water-solubles provide a good source of nutrition for livestock diets. The co-product is usually dried. These could be sold, as one example, as low cost “dried distillers' grains (DDG)” when it has no water-soluble and as “dried distillers' grains with solubles (DDGS)” when it contains water-solubles. Knowing the fact that in a dry mill plant, ethanol and DDGS are produced almost equally on a weight basis, production of 1 liter ethanol generates almost 0.789 kg of DDGS and it can be expected that by 2020 global DDGS production will reach 53.8 million tonnes. Value-addition to co-products is a strong and promising consideration for the sustainability of the bioethanol industry. The low cost of the mentioned co-products has led to research on the topic of composite materials containing distillers' grains. In addition to the filler application in polymeric composites, distillers' grains can also enhance the rigidity of material if appropriate pretreatment, processing conditions and coupling agents are adopted. The challenges pertaining to melt processing of DDGS with plastics at temperatures around 180-200° C. has already been published [2, 3]. These challenges are mainly due to thermal degradation of the soluble portion of DDGS during processing at high temperature. This causes charring of DDGS particles, smell and smoke created while processing and bad surface quality of the injected material. One option to overcome these challenges is to utilize DDG instead of DDGS, proposed in this work. Another option is to reduce the processing temperature to a range of 150-180° C.

In the past 15 years different works have been published in the scientific literature studying the composites of different polymers with distillers' grains. These can be listed as distillers' grains composites with polymers including, (i) polyolefins [4, 5]: polypropylene (PP) and polyethylene (PE); (ii) acrylonitrile butadiene styrene (ABS) [6]; (iii) polyurethane [7]; (iv) phenolic resins [8-10]; (v) biopolymers [2, 3, 11-15]: poly(butylene succinate) (PBS), poly(lactic acid) (PLA), polyhydroxy(butyrate-co-valerate)/poly(butylene succinate) (PHBV/PBS) blend, poly(butylene adipate-co-terephatalate)/polyhydroxy(butyrate-co-valerate) (PBAT/PHBV) blend, and neat P BAT.

Coffee is one of the most consumed beverages in the world. In the production of coffee, green coffee beans obtained by processing the cherries harvested from coffee trees are roasted to give the flavor and aroma of coffee. The thin innermost tegument covering the green coffee beans is called silverskin. It floats free during the roasting process and is often referred to as coffee chaff (CC). The roasted coffee beans are ground and brewed to make coffee. The brewing process extracts soluble matter including caffeine from the coffee ground. The material left over is referred to as spent coffee ground (SCG).

Coffee chaff and spent coffee ground are the main residues generated in the coffee industry and require proper disposal [16]. At present, neither material has found major industrial applications. In some countries, both coffee chaff and SCG are used as fuel [16, 17]. In recent years, there has been growing interest in producing value-added compounds from coffee chaff and spent coffee ground. The silver skin of coffee beans has been investigated as a source for dietary fibers [18, 19]. It has also been shown that the silver skin can provide antioxidant activity [20]. In one study, CC along with other biofibers were tested as fillers to reinforce feather keratin polymer, which was plasticized by glycerol [21]. CC was found to improve the modulus of the polymer to the same extent as hemp and flax fibers. However, adding the fillers reduced both the stress at break and strain at break.

An effective utilization of fibers derived from renewable resources provides environmental benefits with respect to ultimate disposability. Natural fibers have many advantages compared to synthetic fibers such as: more economical; biodegradable; renewable; light weight; reduced reliance on petroleum oil; reduced tool wear; good specific strength; and minimize hazardous materials emission (noxious gases or solid residue) during combustion [22, 23]. Perennial grasses (such as miscanthus and switchgrass) are typical lignocellulosic non-food biomass with increasing production rate for energy production purposes. These grasses grow rapidly compared to some other crops. If such biomass is successfully incorporated into a polymer matrix, it could still increase the revenues for growers. There are many advantages cultivating and utilizing perennial grasses such as low cost, high yield, low input conditions, low maturation time, soil remediation potential, carbon dioxide balance in environment, and underground carbon sequestration.

It is well known that natural fibers are hydrophilic in nature [24] which is incompatible with most hydrophobic polymer matrices, which leads to inferior mechanical performance of the resulting biocomposites. Therefore, various strategies have been made in order to overcome these drawbacks in biocomposites [25]. Among them, compatibilizing agents are widely used to improve interfacial adhesion between the fiber and the biodegradable polymer matrix [26-30]. A reactive compatibilizer is a good choice for producing compatibilized composites/blends. The reactive compatibilization involves forming the block or graft copolymer in-situ during blend preparation via interfacial reaction of added functionalized polymeric components. Maleic anhydride (MAH) grafted polymer is a well-known reactive compatibilizer. For example, MAH grafted polypropylene (MAH-g-PP) is widely used as a compatibilizer in polypropylene blends [31] and composites [32].

Recently, this research has expanded to the biodegradable and/or compostable polyesters such as poly (lactic acid) (PLA) [33], poly (hydoxybutyrate-co-valerate) (PHBV) [28], poly (butylene adipate-co-terephthalate) (PBAT) [34], poly (butylene succinate) (PBS) [35], and polycaprolactone (PCL) [36]. Maleic anhydride grafted copolymers have been shown to be a good interfacial adhesion promoter in the biodegradable polymer based blends [37] and composites [26]. Muthuraj et al. [38] produced and evaluated polymer composites of PBS and miscanthus, with and without maleic anhydride (MAH) grafted PBS (MAH-g-PBS). They observed that the MAH-g-PBS compatibilizer improves the interfacial adhesion between the polymer and miscanthus resulting in significant increase in flexural and tensile strength in comparison with the uncompatibilized composite counterpart.

Keener et al. [39] used a commercially available and economically produced maleic anhydride (MAH) grafted polymer as a compatibilizing agent for fabricating biocomposites. Tserki et al. [26] reports the effect of cotton fiber on the mechanical properties of poly(butylene succinate-co-butylene adipate) (PBSA) with and without MAH grafted PBSA (MAH-g-PBSA) as a compatibilizing agent. A similar type of study has been reported in the poly(3-hydroxy-co-3-hydroxyvalerate) (PHBV)/kenaf fiber biocomposites [28]. Moreover, Kim et al. [27] used MAH grafted polymers as a compatibilizer for bamboo and wood flour filled PBS and poly(lactic acid) PLA biocomposites. In these composites, MAH grafted PBS (MAH-g-PBS) and MAH grafted PLA (MAH-g-PLA) showed better improvements in mechanical and thermal properties when compared to other maleated compatibilizers. In other studies, maleic anhydride (MA) was grafted onto polylactic acid (PLA) by reactive extrusion using 2,5-dimethyl-2,5-di-(tert-butylperoxy)hexane (Lupersol 101) as the free radical initiator [40, 41].

Currently, biocomposite fabrication using blends of polymer matrices is part of the growing trend because blend matrices could provide a stiffness-toughness balance, or tailored properties for resulting biocomposites.

PHBV/PBAT blend, available under the name of ENMAT, is produced by Tianan Biologic Materials Company. Ltd., China [42]. BASF commercialized a biodegradable polymer blend under the trade name of Ecovia. It is a blend of PLA/PBAT with 45 wt. % biobased content [43]. In addition, FKuR is producing PLA-Copolyester blends under the trade name Bio-Flex. These blends are successful in the fabrication of biocomposites and have many natural fibers/fillers.

Nagarajan et al. [44] studied a new engineering biocomposites fabrication process with a pre-blend of PHBV/PBAT (45/55%) with the matrix and switch grass fiber (up to 30 wt. %) as the reinforcement. They discovered that poor interfacial adhesion between the fibers and matrix resulted without compatibilizer. The interfacial adhesion was improved by adding poly(diphenylmethane diisocynate), (PMDI) as a compatibilizer. Javadi et al. [42] studied the processing and characterization of solid and microcellular pre-blends of PHBV/PBAT and its recycled wood fiber (RWF) based composites with and without silane treatment. Commercially available pre-blends of PLA/PBAT (BASF-Ecovio) with chemically treated curaua fiber reinforced biocomposites were studied by Fernanda et al. [43]. This composite was studied with and without addition of compatibilizer i.e., maleic anhydride-grafted-polypropylene (MA-g-PP). More recently, a comparison study between PLA/30% ramie composites and PLA/PBAT/30% ramie composites has been investigated by Yu and Li [45]. Johnson et al. [46] have studied Mater-Bi®/miscanthus fiber composites and they found that the impact properties were significantly increased as compared to neat polymer. Moreover, it has been reported that with the addition of miscanthus fibers into poly(vinyl alcohol) (PVA)/poly(vinyl acetate) (PVAc) blend resulted in superior flexural properties than PVA/PVAc blend [47]. The effect of incorporating 30 wt. % soy hull, switchgrass, miscanthus and their hybrids as a reinforcement in the PHBV/PLA (70/30 wt. %) blend matrix has been investigated by Nanda et al. [48].

A number of patents and patent applications have been filed that disclose material formulations and/or techniques that include distillers' grains, coffee chaff, spent coffee ground, perennial grasses such as miscanthus, and grafted biodegradable polymer blend.

US Pat. Appl. Publ. No. 20050101700 discusses a “biopolymer” formulation from fermentation solids, such as DDG and DDGS, and thermoactive materials. The thermoactive material can be chosen from a very broad range of polymers from thermoplastic to thermoset and from petroleum-based to renewable resource-based. The composite preparation can be performed through different methods such as thermal kinetic compounding, extruding, high shear mixing compounding, or the like. US Pat. Appl. Publ. No. 20050075423 and US Pat. Appl. Publ. No. 20050019545 provide some product examples made of the formulation disclosed in the first patent.

In US Pat. Appl. Publ. No. 20070135536 dried distillers' grains with solubles (DDGS) are used in a material composition along with a binder for adhesion of the DDGS particles. The binder is a polyurethane prepolymer, which is synthesized through the reaction between a polyol and an isocyanate. In this document, the method of producing tough sheets from the formulation is described via a two-step process; extrusion and compression molding.

US Pat. Appl. Publ. No. 20070036958 discloses a material formulation including a reinforcement, a resin, and a filler. The filler is at least one agricultural grain such as corn, or a refined product like starch or flour, or by-product of ethanol production like DDG. The production method is first, putting the reinforcement (for example in the form of a fiber cloth) on a layout table and then injecting the resin in which the filler is integrated. The filler can also be placed in the reinforcement as well. Final step is curing the resin.

In US Pat. Appl. Publ. No. 20090110654 the discussed material formulation consists of a plastic (applicable to a wide range) and a biological material such as DDG. The formulation contains an odor controlling agent to eliminate the undesired odor created during processing of the biological materials. The biological material may undergo pre-treatment before processing with the plastic such as hydrolysis, classification and/or cryogenic grinding. The production technique is very versatile and can be through different methods including extrusion, injection molding, injection blow molding, compression molding, co-extrusion and/or thermoforming.

US Pat. Appl. Publ. No. 20100017347 is an example application of the formulations developed in either of the previous two patent applications.

An elastomeric composite from synthetic rubbers and agricultural products and/or by-products such as DDGS is disclosed in US Pat. Appl. Publ. No. 20100210770. The production technique involves two steps; premixing of the rubber and the filler and then curing the rubber.

U.S. Pat. No. 7,786,187 discloses a method to enhance the resistance to mold of the lignocellulosic filled thermoplastics and prevent the visual surface damage caused thereby. This is claimed to achieve by application of certain fungicide and coupling agents.

To the best of our knowledge, there are only a few patents/patent applications including coffee chaff, spent coffee ground and/or perennial grasses, specifically miscanthus and switchgrass, in composite materials application. These patents/patent applications are US Pat. Appl. Publ. No. 20070259584, U.S. Pat. No. 3,499,851, WO2006059112 and US Pat. Appl. Publ. No. 2012/0071591

A family of US patents by Wang et al. (U.S. Pat. Nos. 6,552,124, 5,952,433, 6,579,934 and 6,500,897), discloses modifying biodegradable polymers and their blends by grafting polar functional groups onto the backbone of the biodegradable polymers through reactive extrusion. No use of such modified biodegradable polymers as compatibilizer in composite materials has been reported yet; neither has the utilization of grafting method through reactive extrusion in a single-step in-situ technique for the compatibilization of polymer matrix and the filler/reinforcing agents in a composite material.

### SUMMARY OF THE INVENTION

The present invention relates to biodegradable, composites comprised of thermoplastic polymers and appreciable amounts of biomass hybrid of different types, exhibiting improved strength, rigidity, elongation, toughness and melt flow behavior, or a balanced combination of these characteristics relative to the composites of the prior art. In one aspect, the composite material formulation is designed to exhibit higher elongation compared to common natural fiber composite.

The composites of the present invention utilize synthesized compatibilizers based on polymer blends of two or more biodegradable polymers. The present invention relates also to an inventive approach for the production of compatibilized composite materials in a single-step in-situ technique.

In one embodiment, the present invention relates to a biodegradable composite. The biodegradable composite, in one embodiment, includes: (a) a polymeric matrix comprising one or more biodegradable polymers; (b) a filler, the filler selected from the group consisting of one or a combination of two or more of the following: (i) by-products from coffee and/or tea, (ii) perennial grasses and/or agricultural residues, (iii) co-products of grain-based ethanol industries including distillers' dried grains (DDG), distillers' dried grains with solubles (DDGS), fibre, protein-rich meals, gluten meals, and gluten feeds, and (iv) inorganic fillers; and (c) an anhydride grafted compatibilizer, the anhydride grafted compatibilizer comprising one or more biodegradable polymers modified with an anhydride group. The one or more biodegradable polymers in the compatibilizer being similar to or different from biodegradable polymers in the polymeric matrix. In one aspect of the present invention the polymeric matrix includes 2 (binary), 3 (ternary) or 4 (quaternary) biodegradable polymers. In another aspect of the invention “the polymeric matrix includes more than 4 biodegradable polymers, such as 5, 6, 7, 8, 9, 10 or greater than 10.

In one embodiment of the biodegradable composite of the present invention, the number of biodegradable polymers in the compatibilizer is equal to or less than or more than the number of biodegradable polymers in the polymeric matrix.

In one embodiment of the biodegradable composite of the present invention, the polymeric matrix is a binary polymeric matrix and the compatibilizer is a binary compatibilizer.

In another embodiment of the biodegradable composite of the present invention, the polymeric matrix is a ternary polymeric matrix and the compatibilizer is a binary compatibilizer.

In another embodiment of the biodegradable composite of the present invention, the polymeric matrix is a ternary polymeric matrix and the compatibilizer is a ternary compatibilizer.

In another embodiment of the biodegradable composite of the present invention, the polymeric matrix is a quaternary polymeric matrix and the compatibilizer is a quaternary compatibilizer.

In one embodiment of any of the previous embodiments of the biodegradable composite of the present invention, the biodegradable polymers are selected from the group consisting of: poly(butylene adipate-co-terephthalate (PBAT), poly(lactic acid) (PLA), poly(butylene succinate) (PBS), poly(butylene succinate-co-adipate) (PBSA), polycaprolactone (PCL) and polyhydroxalkanoates (PHA).

In another embodiment of any of the previous embodiments of the biodegradable composite of the present invention, the biodegradable composite comprises up to 50% by weight of the filler.

In another embodiment of any of the previous embodiments of the biodegradable composite of the present invention, the biodegradable composite comprises two or more of the fillers.

In another embodiment of any of the previous embodiments of the biodegradable composite of the present invention, the by-product is coffee chaff, coffee husk, coffee ground, spent coffee, or spent tea leaves.

In another embodiment of any of the previous embodiments of the biodegradable composite of the present invention, the perennial grasses include miscanthus, switchgrass and bamboo.

In another embodiment of any of the previous embodiments of the biodegradable composite of the present invention, the agricultural residues include straws, stalks and leaves.

In another embodiment of any of the previous embodiments of the biodegradable composite of the present invention, the biodegradable composite comprises between about 0.01 and 15% by weight of the compatibilizer.

In another embodiment of any of the previous embodiments of the biodegradable composite of the present invention, the biodegradable composite further comprises one or more polymer processing additives. In one aspect of the invention the one or more polymer processing additives include a polymer chain extender and/or a plasticizer.

In another embodiment of any of the previous embodiments of the biodegradable composite of the present invention, the biodegradable composite comprises between about 0.01 and 10% by weight of polymer processing additives.

In another embodiment of any of the previous embodiments of the biodegradable composite of the present invention, the biodegradable composite comprises at least 20% by weight of biobased content.

In another embodiment of any of the previous embodiments of the biodegradable composite of the present invention, the biodegradable composite comprises at least 20% by weight of renewable materials.

In another embodiment of any of the previous embodiments of the biodegradable composite of the present invention, the biodegradable composition is in the form of a pellet, a granule, an extruded solid, an injection moulded solid, a thermoformed solid, a vacuum formed solid, a hard foam, a compression moulded or an extruded sheet, a dough or a melt.

In another embodiment of any of the previous embodiments of the biodegradable composite of the present invention, the biodegradable composite is compostable.

The present invention, in another embodiment, relates to an in-situ method of manufacturing a biodegradable composite, the in-situ method includes: (a) melting one or more biodegradable polymers in the presence of a functional monomer and a free radical initiator to form a mixture; and

(b) adding a filler to the mixture, the filler selected from the group consisting of one or a combination of two or more of the following: (i) by-products from coffee, tea or both, (ii) perennial grasses and agricultural residues, (iii) co-products of grain-based ethanol industries including distillers' dried grains (DDG), distillers' dried grains with solubles (DDGS), gluten meals, kernel fibre and gluten feeds, and (iv) inorganic fillers.

In one aspect of the present invention step (a) comprises melting 2 (binary), 3 (ternary) or 4 (quaternary) biodegradable polymers. In another aspect of the invention step (a) comprises melting more than 4 biodegradable polymers, such as 5, 6, 7, 8, 9, 10 or greater than 10.

In one embodiment of the in-situ method of the present invention step (a) includes melting two biodegradable polymers.

In another embodiment of the in-situ method of the present invention step (a) comprises melting three biodegradable polymers.

In another embodiment of the in-situ method of the present invention step (a) comprises melting four biodegradable polymers.

In another embodiment of the in-situ method of the present invention step (a) comprises melting the one or more biodegradable polymers with polymer processing additives. In one aspect, the polymer processing additives include a polymer chain extender and/or a plasticizer. In another aspect, step (a) comprises melting the one or more biodegradable polymers with between about 0.01 and 10% by weight of the polymer processing additives.

The present invention relates, in another embodiment, to a method of manufacturing a biodegradable composite. Solely for the convenience of this Summary section, this method is referred to as the “sequential processing method.” The sequential processing method, according to one embodiment, includes: (a) synthesizing a compatibilizer by: (i) mixing a free radical initiator and a functional monomer, (ii) melting one or more biodegradable polymers to form a melt, and (iii) combining the mixture of step (i) and the melt of step (ii) thereby synthesizing a compatibilizer; and (b) melt-mixing the compatibilizer of step (a), with a matrix of biodegradable polymers and one or more fillers, thereby manufacturing the biodegradable composite. The one or more biodegradable polymers in the compatibilizer being similar to or different from biodegradable polymers in the matrix of biodegradable polymers.

In one embodiment of the sequential processing method of the present invention, the number of biodegradable polymers in the synthesized compatibilizer being equal to or less than or more than the number of biodegradable polymers in the matrix.

In one embodiment of the sequential processing method, step (a)(ii) comprises melting two biodegradable polymers and the biodegradable matrix comprises two biodegradable polymers.

In another embodiment of the sequential processing method, step (a)(ii) comprises melting two biodegradable polymers and the biodegradable matrix comprises three biodegradable polymers.

In another embodiment of the sequential processing method, step (a)(ii) comprises melting three biodegradable polymers and the biodegradable matrix comprises three biodegradable polymers.

In another embodiment of the sequential processing method, step (a)(ii) comprises melting two biodegradable polymers and the biodegradable matrix comprises four biodegradable polymers.

In another embodiment of the sequential processing method, step (a)(ii) comprises melting three biodegradable polymers and the biodegradable matrix comprises four biodegradable polymers.

In another embodiment of the sequential processing method, step (a)(ii) comprises melting four biodegradable polymers and the biodegradable matrix comprises four biodegradable polymers.

In one embodiment of the in-situ method and the sequential processing method of the present invention, the biodegradable polymers are selected from the group consisting of: poly(butylene adipate-co-terephthalate) (PBAT), poly(lactic acid) (PLA), poly(butylene succinate) (PBS), poly(butylene succinate-co-adipate) (PBSA), polycaprolactone (PCL) and polyhydroxalkanoates (PHA).

In another embodiment of the in-situ method and the sequential processing method of the present invention, the functional monomer is maleic anhydride or a structural analogue or derivative thereof.

In another embodiment of the in-situ method and the sequential processing method of the present invention, the free radical initiator is selected from benzoyl peroxide and dicumyl peroxide.

In another embodiment of the in-situ method and the sequential processing method of the present invention, the filler is selected from the group consisting of one or a combination of two or more of the following: (i) by-products from coffee and/or tea, (ii) perennial grasses and/or agricultural residues, (iii) co-products of grain-based ethanol industries including distillers' dried grains (DDG), distillers' dried grains with solubles (DDGS), kernel fibre, protein-rich meals, gluten meals, and gluten feeds, and (iv) inorganic fillers;

In another embodiment of the in-situ method and the sequential processing method of the present invention, the by-product is coffee chaff, coffee husk, coffee ground, spent coffee, or spent tea leaves.

In another embodiment of the in-situ method and the sequential processing method of the present invention, the perennial grasses include miscanthus, switchgrass and bamboo.

In another embodiment of the in-situ method and the sequential processing method of the present invention, the agricultural residues include straws, stalks and leaves.

In another embodiment of the in-situ method and the non-in-situ method of the present invention, the biodegradable composite comprises between about 0.01 and 15% by weight of the compatibilizer.

In another embodiment of the in-situ method and the sequential processing method of the present invention, the biodegradable composite further comprises a polymer chain extender and/or a plasticizer. In one aspect of the invention the polymer processing additives include a polymer chain extender and/or a plasticizer.

In another embodiment of the in-situ method and the sequential processing method of the present invention, the biodegradable composite comprises between about 0.01 and 10% by weight of polymer processing additives.

In another embodiment of the in-situ method and the sequential processing method of the present invention, the biodegradable composite comprises at least 20% by weight of biobased content.

In another embodiment of the in-situ method and the sequential processing method of the present invention, the biodegradable composite comprises at least 20% by weight of renewable materials.

In one embodiment of the composites or methods of the present invention, the filler is provided in a pre-treated from having a substantially reduced odor relative to the filler in an untreated form.

### BRIEF DESCRIPTION OF THE DRAWINGS

The following figures illustrate various aspects and preferred and alternative embodiments of the invention.

FIG. 1: Basic construction of an extruder used for the manufacture of biocomposite (obtained from the manual of the Leistritz extruder, type MIC/GL-480 convertible from co- to counter-rotating).

FIG. 2: Injection moulded part made of an in-situ compatibilized ternary matrix with 25 wt. % filler/reinforcing agent (DDG and talc).

FIG. 3: Injection moulded part made of a binary matrix and 30 wt. % miscanthus compatibilized with a binary blend based synthesized compatibilizer.

### DESCRIPTION OF THE INVENTION

### Definitions

Unless defined otherwise, all technical and scientific terms used herein have the same meaning as commonly understood by one of ordinary skill in the art to which this invention belongs. Also, unless indicated otherwise, except within the claims, the use of “or” includes “and” and vice versa. Non-limiting terms are not to be construed as limiting unless expressly stated or the context clearly indicates otherwise (for example “including”, “having” and “comprising” typically indicate “including without limitation”). Singular forms included in the claims such as “a”, “an” and “the” include the plural reference unless expressly stated otherwise. All relevant references, including patents, patent applications, government publications, government regulations, and academic literature are hereinafter detailed and incorporated by reference in their entireties. In order to aid in the understanding and preparation of the within invention, the following illustrative, non-limiting, examples are provided.

The prefix “bio-” or “bio” is used in this document to designate a material that has been derived from a renewable resource.

The term “renewable resource” refers to a resource that is produced by a natural process at a rate comparable to its rate of consumption (e.g., within a 100 year time frame). The resource can be replenished naturally, or via agricultural techniques.

The term “biobased content” refers to the percent by weight of a material that is composed of biological products or renewable agricultural materials or forestry materials or an intermediate feedstock.

“Biodegradable” refers to a composite or product capable of being broken down (e.g. metabolized and/or hydrolyzed) by the action of naturally occurring microorganisms, such as fungi and bacteria.

The term “compostable” refers to a composite or product that satisfies requirements, set by ASTM D6400, for aerobic composting in municipal and industrial facilities. In a brief note, a compostable material fulfilling ASTM D6400 requirements is substantially broken down in compost at a rate that is consistent with known compostable materials (e.g. cellulose), disintegrates into small pieces and leaves no toxic residue.

The term “hybrid composite/biocomposite” refers to the composite/biocomposite including any combination of two or more types of different biomass.

The term “biomass hybrid” refers to a combination of two or more types of different biomass.

The term “co-products of grain-based ethanol industries” refers to grain-based fibrous and/or proteineous materials including distillers' dried grains (DDG), distillers' dried grains with solubles (DDGS), kernel fibre, gluten meals, gluten feeds.

The term “distillers' grains” refers to individual or a mixture of co-products from grain-based bioethanol production plant including distillers' dried grains (DDG) and distillers' dried grains with solubles (DDGS).

The term “agricultural residues” refers to materials left in an agricultural field or orchard after the crop has been harvested including straws, stalks, leaves, or materials left after further processing of the grains including, but not limited to, hull, husk, cob.

The term “uncompatibilized composites” refers to a composite formulation that contains no compatibilizer in its formulation, nor has been produced via in-situ compatibilization method.

The terms “wt. %” or “% by weight” refer to the weight percent of a component in the composite formulation with respect to the weight of the whole composite formulation.

The term “about” modifying any amount refers to the variation in that amount encountered in real world conditions of producing materials such as polymers or composite materials, e.g., in the lab, pilot plant, or production facility. For example, an amount of an ingredient employed in a mixture when modified by about includes the variation and degree of care typically employed in measuring in a plant or lab producing a material or polymer. For example, the amount of a component of a product when modified by about includes the variation between batches in a plant or lab and the variation inherent in the analytical method. Whether or not modified by about, the amounts include equivalents to those amounts. Any quantity stated herein and modified by “about” can also be employed in the present invention as the amount not modified by about.

Overview

Henceforth, this document provides detailed description of the embodiments of the present invention. It provides a composition, method or manufacture of bio-composites which may be based on waste/by-products from coffee and/or tea farming and processing industries (including but not limited to coffee chaff, coffee husk, coffee ground, spent coffee, spent tea leaves, etc.) and/or perennial grasses (including but not limited to miscanthus, switchgrass, bamboo) and agricultural residues (including but not limited to agricultural straws, stalks, leaves, etc.) and/or co-products of grain-based ethanol industries (including but not limited to distillers' dried grains, DDG, distillers' dried grains with solubles, DDGS, kernel fibre, gluten meals, gluten feeds) and/or inorganic fillers (including but not limited to talc, clay, calcium carbonate, wollastonite, barium sulfate), a biodegradable matrix composed of thermoplastics which may be reinforced or not with mineral fillers and which may be produced by reactive extrusion suitable for general purpose applications such as plastic containers and the like, and a binary or ternary or quaternary compatibilizer. Conventional extrusion, normally used in the synthetic plastic industries, may also be used in the method of processing.

The present biocomposite may exhibit properties typical of plastic materials, and/or properties advantageous compared to aggregates including plastic and, for example, wood or cellulosic materials.

The present biocomposite may be formed into useful articles using any of a variety of conventional methods for forming items from plastic. The present biocomposite may take any of a variety of forms.

Bio-Composites & Methods of Manufacturing

The present invention is about new and non-obvious material formulations based on one or a hybrid biomass combination of a polymeric matrix with waste/by-products from coffee/tea farming and processing industries (including but not limited to coffee chaff, coffee husk, coffee ground, spent coffee, spent tea leaves, etc.) and/or perennial grasses (including but not limited to miscanthus, switchgrass, bamboo) and agricultural residues (including but not limited to agricultural straws, stalks, leaves, etc.) and/or co-products of grain-based ethanol industries (including but not limited to distillers' dried grains, DDG, distillers' dried grains with solubles, DDGS, kernel fibre, gluten meals, gluten feeds) and/or inorganic fillers (including but not limited to talc, clay, calcium carbonate, wollastonite, barium sulfate), and a binary or ternary or quaternary compatibilizer. The present invention is also about development and production methods of new and non-obvious bio-composites based the mentioned biomass. The present invention has distinguished points compared to the prior art in both aspects of material formulation and production method.

i. Biodegradability: The bio-composites of the present invention may be formulated in such a way that the final manufactured product would have end-of-life biodegradability (compostability) characteristic. To develop such a bio-composite material, the proposed formulation may include a polymeric matrix from biodegradable plastics. It has been reported that the composite of a biodegradable plastic and dried distillers' grains with solubles (DDGS) exhibits enhanced biodegradability characteristic than biodegradable plastic alone [15].

ii. Renewability: The polymer blends used in the present application may be produced, at least in part, from renewable resources. Thus, considering the renewability of the filler/reinforcing agents also, the final formulation can be produced from renewable materials up to 70% by weight of the whole composite. More than 70% by weight may also be possible.

iii. Binary or ternary or quaternary blended matrix with tailored properties: In one embodiment, the developed formulation of the present invention includes a polymeric matrix blend having ‘n’ number of biodegradable polyesters, with ‘n’ being an integer greater than one. The matrix blend may include a combination of biodegradable polyesters including poly(butylene succinate), PBS, poly(butylene succinate-co-adipate), PBSA, poly(butylene adipate-co-terephthalate), PBAT, poly(lactic acid), PLA, polyhydroxalkanoates, PHAs, polycaprolactone, PCL, and the like. Such a blend with a binary (n=2) or ternary (n=3) or quaternary (n=4) combination of these polymers is used for the first time in natural fibers composites. In one aspect of the invention “n” may be a number greater than 4, such as 5, 6, 7, 8, 9, 10 or greater than 10. Blending may benefit from the specific merits of each moiety in order to balance different properties. To create such a balance, the following aspects may be considered simultaneously, each of which introduced to the blend system by one or two of the moieties: Rigidity/Modulus (PHAs, PLA and PBS), Strength (PLA and PBS), Impact strength (PBAT, PCL), Elongation (PBAT, PCL, PBSA), Heat deflection temperature/High-temperature rigidity (PHAs, PBS), Moldability/Melt flow index (PLA, PBS), Renewable resource-based (PHAs and PLA), and Low cost (PLA).

Based on the targeted application with specific requirements, a binary or a ternary or a quaternary blend of these plastics may be considered.

iv. Composites utilizing biomass hybrid: In addition to the composites containing a single biomass, the proposed composite materials based on biomass can be prepared in a hybridized way with a combination of one, two or more fillers/reinforcing agents from waste/by-products from coffee/tea farming and processing industries (including but not limited to coffee chaff, coffee husk, coffee ground, spent coffee, spent tea leaves, etc.) and/or perennial grasses (including but not limited to miscanthus, switchgrass, bamboo) and agricultural residues (including but not limited to agricultural straws, stalks, leaves, etc.) and/or co-products of grain-based ethanol industries (including but not limited to distillers' dried grains, DDG, distillers' dried grains with solubles, DDGS, kernel fibre, gluten meals, gluten feeds) and/or inorganic fillers (including but not limited to talc, clay, calcium carbonate, wollastonite, barium sulfate). Similarly, mineral fillers including but not limited to talc and calcium carbonate can be included in the composite formulations.

Having a hybrid combination of fillers/reinforcing agents in the bio-composite formulation of the present invention may result in advantages such as: benefit from different properties of different fillers/reinforcing agents to be able to tailor the properties; and minimize the risk of lack of supply chain of the fillers/reinforcing agents.

v. Production of an anhydride grafted compatibilizer from one biodegradable polyester, or from a binary or ternary or quaternary blend of biodegradable polyesters: Unlike polyolefin-based biocomposites, there is a lack of suitable compatibilizer/coupling agent in the market for biocomposites from biomass and biodegradable polyesters. In the present invention, a method of producing anhydride grafted polymer has been utilized, for the first time, for one or for a binary or ternary or quaternary blend of biodegradable polyesters such as PBS, PBSA, PLA, PHAs, PCL and PBAT. The use of such compatibilizers provide opportunities in tailoring the properties of the composites made thereof. The one or more biodegradable polymers in the compatibilizer may be similar to or different from biodegradable polymers in the matrix. A non-limiting example of biodegradable polymers in the matrix being different from the biodegradable polymers in the matrix may be a ternary matrix (PHBV/PLA/PBS) compatibilized with a compatibilizer based on PBAT only. The number of biodegradable polyesters in the compatibilizer may be equal to or less than or more than the number of biodegradable polyesters in the blended matrix.

vi. In-situ compatibilization: in another procedure to produce compatibilized biomass-polyester biocomposite, an in-situ compatibilization and compounding in one step is introduced in the present application. In this method, an extruder with several heating zones is used. The biodegradable polyesters are premixed with chemicals comprising the compatibilizer system and fed into the extruder in the first heating zone. The temperature of first few heating zones before the feeding zone of fillers/reinforcing agents is kept at higher value to facilitate fast melting of polyesters and occurrence of necessary chemical reactions. These chemical reactions may involve grafting of desired chemical functional groups onto the polyesters molecular chains. These functional groups may be suitable sites to react with hydroxyl groups abundantly available in the composition of biomass fillers/reinforcing agents. After the first few heating zones, premixed fillers/reinforcing agents may be fed into the extruder. The temperature profile of heating zones from the zone that fillers/reinforcing agents are added to the die connected to the last heating zone is set at relatively lower values so as to avoid unnecessary degradation of different components, however the temperature may be high enough to perform a proper compounding of them.

vii. Odor: It may be an advantage to provide a biodegradable composite with substantially reduced or free of odors, for example of odors that may be associated with the fillers. As such, in another embodiment of the present invention, the filler may be pre-treated to substantially reduce, eliminate or remove odors associated with the filler in its natural or untreated form. The filler may be provided in a form having a substantially reduced odor or free of odor relative to the filler in its natural or untreated form. In one aspect of the present invention, the filler may be provided in bleached form, such as bleached DDGS, bleached coffee chaff, bleached perennial grass and so forth.

In order to aid in the understanding and preparation of the present invention, the following illustrative, non-limiting examples are provided.

### Examples

### 1. Materials

Table 1 includes a list of materials or ingredients that can be used for the production of the novel formulations of the present invention. The polymeric matrix of the biocomposites of the present invention includes biomass derived polymers such as poly(lacticacid) (PLA) or the alike, biodegradable polymers such as poly(butylene adipate-co-terephthalate)(PBAT). It may include or contain other biodegradable reinforcing phases such as poly(butylene succinate) (PBS), polyhydroxyalkanoate (PHAs), polycaprolactone (PCL), poly(butylene succinate-co-adipate)(PBSA), or the like.

TABLE 1
Materials that can be used for the production of the novel formulations
proposed in this application

| Material | Examples | Role |
|---|---|---|
| Polyester polymers | PLA, PBS, PBSA, PBAT, PCL, PHAs, and | Matrix |
| | the like | |
| Co-product of | Grain-based fibrous and/or proteineous | Filler/reinforcing |
| bioethanol based on | materials including dried distillers' grain | agent |
| corn, wheat, or sorghum | with solubles (DDGS), Dried distillers' | |
| | grain (DDG), kernel fibre, gluten meal, | |
| | and the like | |
| Agricultural residues | Agricultural straws, stalks, leaves, hull, | Filler/reinforcing |
| | husk, cob, and the like | agent |
| Perennial grasses | Miscanthus, Switchgrass, bamboo and the | Filler/reinforcing |
| | like | agent |
| Waste/by-products from | Coffee husk, Ground coffee, Spent coffee | Filler/reinforcing |
| coffee/tea farming and | ground, Coffee chaff, Spent tea leaves, and | agent |
| processing industries | the like | |
| Inorganic fillers | Talc, Clay, Calcium carbonate, | Filler/reinforcing |
| | Wollastonite, Barium sulfate, and the like | agent |
| Anhydride-based | maleic anhydride, nadic anhydride, nadic | Grafting agent |
| chemicals | methyl anhydride, octadecenyl succinic | and/or |
| | anhydride, tetradecenyl succinic | compatibilizer |
| | anhydride, hexadecenyl succinic | |
| | anhydride, dodecenyl succinic anhydride, | |
| | tetrapropenyl succinic anhydride, and the | |
| | like | |
| Peroxide-based | Peroxides, Hydroperoxides, Peroxy esters | Free radical initiator |
| chemicals | and Ketone peroxides, and the like. | |
| | For example, dicumyl peroxide (DCP), | |
| | benzoyl peroxide, 2,5 dimethyl 2,5 di(tert- | |
| | butylperoxy) hexane, Lupersol, Luperox, | |
| | etc. | |
| Polymer chain extender | Liquid or solid chain extenders such as | Chain extender |
| | diepoxides, diisocyanates, dianhydrides, | and/or |
| | bis-oxazolines, carbodiimides, and bis- | compatibilizer |
| | dihydrooxazines, modified acrylic | |
| | copolymer with epoxy functions, glycidyl | |
| | methacrylate (GMA) derived polyepoxides | |
| | and the like. For example tris (nonyl | |
| | phenyl) phosphite (TNPP), | |
| | polycarbodiimide (PCDI), Joncryl, 4,4- | |
| | methylene-bisphenylisocyanate (MDI), | |
| | hexamethylenediisocyanate (HMDI), | |
| | phenylene bis-1,4-oxazoline, 2,2-bis- | |
| | oxazoline, etc. | |
| Alkyl citrates or other | triethyl citrate (TEC), acetyl triethyl citrate | Plasticizer and |
| polymer plasticizers | (ATEC), tributyl citrate (TBC) | processing aid |
| | acetyl tributyl citrate (ATBC), and the like | |

The poly(lactic acid) or polylactide can be low or high melt flow index. It can be produced by condensation polymerization or by ring opening polymerization. The poly(lactic acid) produced by ring opening polymerization is known as polylactide resin and the one produced by condensation polymerization is known as poly(lactic acid). In this document the term “poly(lactic acid)” or the acronym “PLA” is used indistinctly to refer either those resins obtained by ring opening polymerization or those by condensation polymerization. Poly(lactic acid) is manufactured by polymerization of monomeric lactic acid. Lactic acid is present in the form of L-type or D-type depending on optical activity. In general, lactic acid can be synthesized by a chemical method using a fossil resource such as coal, petroleum or natural gas. However, lactic acid produced by fermentation of sugars may be preferred and used in the present invention. Sugars can be derived from starch (corn, potato, sugar beet, etc.), molasses, and the like. Poly(lactic acid) is biodegradable and biocompatible and most grades present high tensile strengths (typically 60 MPa) and low elongation at break (typically 3%).

The poly(butylene adipate-co-terephthalate) (PBAT) is a petroleum based aliphatic-aromatic copolymer randomly polymerized from the polycondensation of 1,4-butanediol with both adipic and teraphtalic acids. It has a tensile strength of ˜25 MPa, elongation at break of ˜700%, and high impact strength showing non-break behaviour.

The poly(butylene succinate) (PBS, from succinic acid and butanediol and the like produced by condensation polymerization) is a biodegradable polymer, biocompatible, and bio-absorbable. It has an averaged density of 1.26 g/cm. The melting point of 114° C. may vary with the level of the molecular weight and molecular weight distribution. The degree of crystallinity is ranked between 30 to 45 percent. It can be used to produce general purpose biodegradable materials. The source of production of PBS may be synthetic form oil resources, but it can also be synthetized by fermentation of biological resources. Poly(butylenesuccinate) (PBS) in general presents moderate to high tensile strengths around 30 MPa and good elongation at break during tensile test of around 400%.

Polyhydroxyalkanoates (PHAs) are a big family of biopolymers with a wide range of properties. PHAs are aliphatic polyesters and are mainly produced by bacterial fermentation. PHAs, in homopolymer form, are usually highly crystalline thermoplastics with high melting point (170° C.). Their processability using conventional petroleum-based processing equipments, biocompatibility and biodegradability together with similarity of their material properties to that of some synthetic thermoplastics especially polypropylene and LDPE have made them attractive in order to substitute non-biodegradable thermoplastics. Some homopolymer examples from this family are poly(-3-hydroxybutyrate) (PHB), poly(3-hydroxyvalerate) (PHV), poly(3-hydroxyhexanoate) (PHHx), poly(3-hydroxyoctanoate) (PHO), poly(3-hydroxydecanoate) (PHD), and poly(3-hydroxyoctadecanoate) (PHOd). Some co-polymer examples of PHA family are poly(3-hydroxybutyrate-co-3-hydroxyvalerate) (PHBV), poly(3-hydroxybutyrate-co-3-hydroxyoctanoate) (PHBO), poly(3-hydroxybutyrate-co-3-hydroxyoctadecanoate) (PHBOd), poly(3-hydroxybutyrate-co-3-hydroxydecanoate) (PHBD), poly(3-hydroxybutyrate-co-3-hydroxyhexanoate) (PHBHx), poly(3-hydroxybutyrate-co-3-hydroxyoctanoate) (PHBO).

Polycaprolactone (PCL) is petroleum-based biodegradable polyester. PCL can be synthesized in two ways, (i) ring opening polymerization of ε-caprolactone using anionic, cationic or co-ordination catalysts, (ii) free radical ring-opening polymerization of 2-methylene-1-3-dioxepane. It is a tough, semi-crystalline polymer which exhibits elongation-at-break of as high as 700%. It has a low melting point of around 60° C. and a glass transition temperature (Tg) in the range of −65 to −60° C. PCL is often blended with other polymers to improve their processing and properties (e.g., impact resistance). Talc, clay, or calcium carbonate may be used as fillers. The talc used in these compositions are composed of SiO2 in variables percentages (averaged in 60%), MgO (30%), Al2O3 (4%), and others such as Fe2O3 and CaO (6%), and others. Talc particles may present a particle size between 1 and 5 microns. The talc may present different degrees of lamellar structure or it can be delaminated in various degrees during the process of extrusion. The delamination process may result in better performance of the composites. The talc sources to use are those preferentially used to strengthen thermoplastics. The amount of talc may be preferentially up to 5 wt. % relative to the 100% of the composition. The preferred talc used in this invention present a surface area (B.E.T. ISO 9277) of 20 m²/g or it may be lower.

Dried distillers' grains (DDG) and dried distillers' grains with solubles (DDGS) are co-products obtained after the fermentation of corn, wheat, or sorghum. Fermentation of these grains is of enormous importance to brewers and distillers, bakers and chemical manufacturers. Fermentation of corn grains for the production of ethanol as a fuel generates huge amounts of these materials. The process of ethanol generally involves a two-step enzymatic process from starch to glucose and glucose to ethanol with the consequent distillation of ethanol and recovery of carbon dioxide. Corn is the grain of choice for the synthesis of ethanol. Since only the starch fraction is used during this process and as conventional processed one third of the material is a co-product. These co-products are used in these compositions as reactive fillers embedded in a polymeric matrix.

Coffee and tea are two of the most consumed beverages in the world. In the production of coffee, green coffee beans obtained by processing the cherries harvested from coffee trees are roasted to give the flavor and aroma of coffee. The thin innermost tegument covering the green coffee beans is called silver skin. It floats free during the roasting process and is often referred to as coffee chaff (CC). The roasted coffee beans are ground and brewed to make coffee. The brewing process extracts soluble matter including caffeine from the coffee ground. The material left over is referred to as spent coffee ground (SCG).

Perennial grasses are typical lignocellulosic biomass and promising non-food crop which grow rapidly compared to some other crops. If this biomass could be successfully incorporated into polymer matrix, it could still increase the revenues for growers. There are lots of advantages of perennial grasses as reinforcement in polymeric composites over other lignocellulosic biomasses, such as low cost, high yield, low input conditions, low maturation time, soil remediation potential, carbon dioxide balance in environment, and underground carbon sequestration. The key strategy is the combination of bioplastics with perennial grasses in order to create cheap sustainable biocomposites. The advantages of using perennial grasses in this work are their good reinforcement properties and the strong potential for a reliable supply chain. The modulus and hardness value of some types of perennial grass fibers by nanoindentation method have been reported as 9.49 GPa and 0.34 GPa, respectively. These properties are quite comparable with other agro fibers such as hemp and sisal.

The free radical initiator consists of organic peroxide group compounds or azo group. The organic peroxide may be in the form of peroxides, hydroperoxides, peroxy esters and ketone peroxides. The anhydride is an unsaturatued cyclic monomer or mono substituted (aliphatic side chain) unsaturatued cyclic monomer. Preferably the anhydride is maleic anhydride, nadic anhydride, nadic methyl anhydride, octadecenyl succinic anhydride, tetradecenyl succinic anhydride, hexadecenyl succinic anhydride, dodecenyl succinic anhydride, tetrapropenyl succinic anhydride.

Thermal and hydrolytic degradation is a common phenomenon happening during melt processing of thermoplastic polyesters primarily due to the residual moisture content in the polymer. This leads to the chain scission on the polymer backbone and reduction in molecular weight. Polymer chain extenders are thermally stable low-molecular weight chemicals in liquid or solid state that prevent or reduce the occurrence of this phenomenon by fast reactions with the hydroxyl or carboxyl end groups of polyesters, thus linking two or more polymer chains. Similar mechanism can be responsible for linking hydroxyl or carboxyl groups of different polymer chains in a blend of two or more polyesters, between polymer chains or with hydroxyl groups of a biomass such as natural fibres. The polymer chain extenders may be in the form of diepoxides, diisocyanates, dianhydrides, bis-oxazolines, carbodiimides, and bis-dihydrooxazines, modified acrylic copolymer with epoxy functions, glycidyl methacrylate (GMA) derived polyepoxides and the like. For example tris (nonyl phenyl) phosphite (TNPP), polycarbodiimide (PCDI), Joncryl®, 4,4-methylene-bisphenylisocyanate (MDI), hexamethylenediisocyanate (HMDI), phenylene bis-1,4-oxazoline, 2,2-bis-oxazoline, etc.

Plasticizers are often used in polymer processing to increase the flow of the polymer melt, ease the compounding of the polymer melt with reinforcing agents and fillers, and improve the flexibility of the final material. The plasticizers in this invention include, but not limited to, alkyl citrates or other polymer plasticizers such as triethyl citrate (TEC), acetyl triethyl citrate (ATEC), tributyl citrate (TBC), acetyl tributyl citrate (ATBC), and the like

### 2. Methods

The compositions produced by the following methods can be used for general purposes including but not limited to plastic containers as well as degradable and disposable items such as flower pots, food and coffee trays, horticultural trays, storage bins, disposable consumer products, food packaging, single-use containers, parts, tool boxes, bathroom accessories, dust pans, spray guns and the like.

### 2.1. Production of In-Situ Compatibilized Composites

Prior to melt processing, the polyesters and the fillers/reinforcing agents were dried at 80° C. for at least 12 h. The methods related to an in-situ reactive extrusion are performed in presence of a functional monomer and a free radical initiator. The agent for grafting used in the following examples is maleic anhydride (MAH) also known as 2,5-furandione, dihydro-2,5-dioxofuran, toxilic anhydride, or cis-butenedioicanhydride. The in-situ modification may consist in grafting and graft copolymerization of saturated or unsaturated polymers during reactive extrusion in presence of free radical initiator, including benzoyl peroxide, dicumyl peroxide, or the alike. The free radical initiator should be suitable to be used at the temperatures at which the polymers melt. Isostructural analogues of MAH such as maleimides and maleates, anhydrides, esters and imides of citraconic and itaconicacids, derivatives of maleic acid, derivatives of fumaric acid, etc. can also be used to produce grafting of the polymers.

The reaction of molten polymers as described above with MAH in the presence of a free radical initiator can be performed on Brabender Plasticorder, Haake mixers or the like, micro-compounders with integrated extrusion and injection molding systems (i.e. DSM micro-injection molding), or in any extruder normally used to process thermoplastic polymers. When an extruder is used, which is the preferred method of processing, strands are produced in a continuous process which can be pelletized and further processed by injection molding into the desired shape. The use of twin-screw extruder systems is determinant in the production of inexpensive materials and it is a rapid way to obtain in mass commercially valuable polymers.

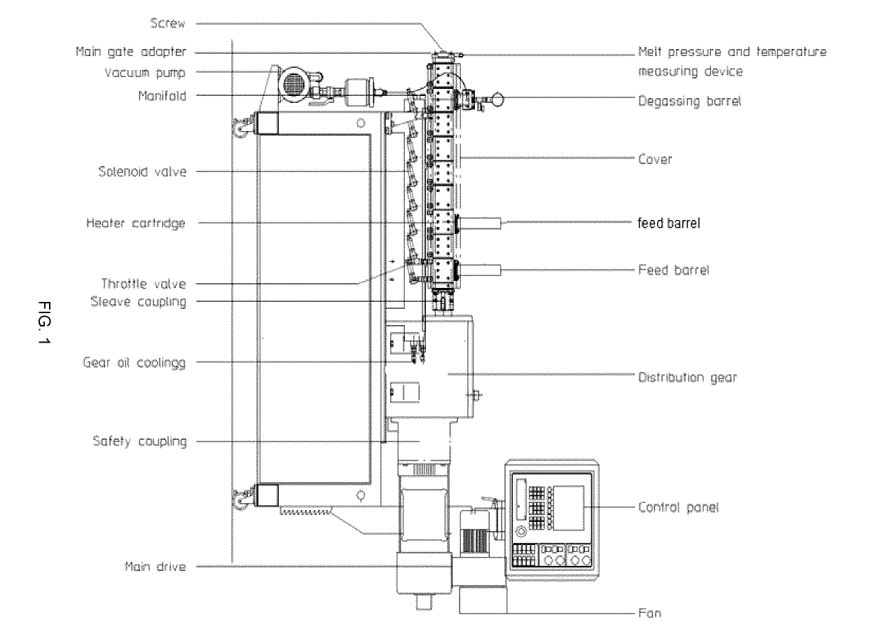

The basic construction of an extruder used to process biomaterials is shown in FIG. 1. The twin-screw extruder used in the present work had 27-mm diameter screws manufactured by Leistritz, Germany. This extruder may present 10 heating zones or less. It may require degassing pump if a reactive extrusion is performed. It shall present two feed barrel zones by which indistinctly the polymers and the biomaterials are fed. Preferentially, the matrix thermoplastics in presence of the above-mentioned reactive system (MAH or the like, DCP or the like) are fed firstly in order to melt down the polymers and initiate the maleation reaction. Once the matrix is being fed, the filler/reinforcing agent is fed at a speed based on the desired weight percentage of the filler/reinforcing agent in the composite. The temperatures of processing may vary from 120 to 200° C., or any range in between 120 and 200° c. The processing conditions are listed in Table 2.

TABLE 2
Extrusion parameters and additive concentrations used for
fabrication of in-situ compatibilized composites

| Parameters | Conditions | |
|---|---|---|
| Processing temperature | 120-200° | C. |
| Screw speed | 50-150 | rpm |
| Residence time | 0.5 to 7 | minutes |
| Filler/reinforcing agents | 0.01 to 40 | wt. % |
| Combined free radical initiator | 0.01 to 3 | wt. % |
| and anhydride grafting agent | | |
| Anhydride grafting agent to free | 5-15 | phr |
| radical initiator ratio | | |

### 2.2. Synthesis of Compatibilizers

In the batch processing approach, the compatibilizers were prepared through (i) pre-mixing a free radical initiator and an anhydride grafting agent, (ii) melting one or any combination of two or three of the aforementioned polyesters above the melting point of the polyesters for an appropriate amount of time until the torque measured and recorded by the batch mixer reaches a constant value, (iii) adding the pre-mixture of the free radical initiator and the anhydride grafting agent to the molten binary or ternary or quaternary polyesters and (iv) continuing the melt mixing at the temperature above the melting point of the polyesters for an appropriate amount of time provided in Table 3 in order to graft pendant anhydride groups onto polyester backbone. In the examples provided in the present application, the batch processing was performed in a HAAKE PolyLab QC (Thermo Scientific) machine.

In the continuous processing approach, the free radical initiator, the anhydride grafting agent and one or any combination of two or three aforementioned polyesters are pre-mixed and extruded. In the examples provided in the present application, the continuous processing was conducted in a twin-screw extruder manufactured by Leistritz, Germany.

The melt mixing process can be performed in any thermoplastics batch or continuous processing equipment including, but not limited to, Brabender Plasticorder, Hakke mixer, or extruders (single or twin screw). The grafting reaction can be performed using following processing parameters:

TABLE 3
Extrusion parameters and additive concentrations used
for synthesizing the compatibilizers

| Parameters | Conditions | |
|---|---|---|
| Processing temperature | 120-190° | C. |
| Screw speed | 50-150 | rpm |
| Residence time | 1 to 10 | minutes |
| Free radical initiator concentration | 0.1 to 3 | phr |
| Anhydride grafting agent | 1-15 | phr |

Un-reacted or excess anhydride from the synthesized compatibilizers can be removed by three ways: (1) applying vacuum to vent off volatile during extrusion process, (2) drying synthesized compatibilizers under vacuum at 95° C. until the desired level of un-reacted anhydride in the compatibilizer is reached, (3) solvent purification.

### 2.3. Pre-Treatment of Biomass

All biomass shown in Table 1 may undergo pre-treatments, which are common for natural fibres prior to composite production. Those pre-treatments include alkali treatment or mercerization, silanization, bleaching, water washing, detergent washing, acetylation, etc.

In this application, examples of composites containing biomass filler treated with two separate methods, water washing and bleaching, are provided.

Water washing was performed with soaking and manually stirring the biomass in tap water at room temperature for 10 to 15 minutes. The ratio of water to biomass, the temperature of water, and the duration of soaking and stirring may vary based on the biomass. Washed biomass was filtered by passing through a mesh screen of approximately 1 mm porosity size and then dried.

The bleaching was performed with soaking and stirring the biomass in peracetic acid (10 wt. %) solution at 50 to 60° C. for 30 minutes. The bleaching solution, ratio of solution to biomass, the temperature of the solution and the duration of bleaching reaction may vary based on the biomass. The treated biomass was filtered by passing through a polypropylene mesh screen of 150 micron porosity size and then washed with distilled water and again filtered to give the bleached biomass.

All biomass used in the examples herein below have been dried at 80 degree C. for at least 6 hours prior to composite compounding to remove residual moisture of the biomass.

### 2.4. Production of Composites Compatibilized by a Synthesized Compatibilizer

Prior to melt processing, the polyesters and the fillers/reinforcing agents were dried at 80° C. for at least 6 h. The composites were prepared by incorporating up to 50 wt. % of filler/reinforcing agent into a single polymer, or binary blend, or ternary blend, or quaternary blend of the matrix polymers. The composites include up to 15 wt. % synthesized compatibilizer based on a single polymer, or binary blend, or ternary blend, or quaternary blend of the matrix polymers. Also, the composites may include up to 10 wt. % polymer additives including polymer chain extenders and/or plasticizers.

The compounding can be carried out in any traditional batch mixers or extruder machines, more preferable a twin-screw extruder. In the examples provided in this invention, the compoundings were carried out either in small scale in a DSM Xplore machine, The Netherlands, or in large scale in a twin-screw Leistritz extruder, Germany. The typical range of processing parameters is listed below.

TABLE 4
Extrusion parameters and additive concentrations used for fabrication of
composites with synthesized compatibilizer

| Parameters | Conditions | |
|---|---|---|
| Processing temperature | 120-200° | C. |
| Screw speed | 50-150 | rpm |
| Residence time | 0.5 to 7 | minutes |
| Filler/reinforcing agents | 0.01 to 50 | wt. % |
| Synthesized compatibilizer | 0.01-15 | wt. % |

### 2.5. Sample Preparation

The extruded pellets can be shaped into desired geometry by any conventional polymer processing technique including but not limited to injection molding, compression molding, vacuum forming, sheet extrusion and thermoforming.

In the examples provided in this application, tensile, flexural and impact test bars were manufactured from the pellets either by using an injection molding machine, Arburg ALLROUNDER, Germany, with capacity of 77 tons or by using a micro-injection molding instruments (i.e., DSM Explore, Netherlands). The extruded pellets from the Leistritz extruder were injection molded at 140-200° C., using a 77 ton injection molding machine manufactured by Arburg ALLROUNDER, Germany. In another method, the extruded pellets were melted in a micro-compounder followed by immediate injection in a micro-injector both manufactured by DSM Xplore, The Netherlands, in the above-mentioned range of temperature.

Finally, when the composite material was produced in the DSM micro-extruder, the composite material melt coming out of the extruder die was collected in melt transfer device and injected immediately into the test bars using a DSM micro-injector.

### 2.6. Testing and Characterization

Specimens to measure the tensile and flexural properties as well as the impact strength and melt flow index (MFI) were produced and tested according to the following standards ASTM: D638 (standard test method for tensile properties of plastics), D790 (standard test method for flexural properties of unreinforced and reinforced plastics and electrical insulating materials), D256 (notched-izod; standard test methods for determining the Izod pendulum impactresistance of plastics), D1238 (standard test method for melt flow rates of thermoplastics by extrusion plastometer). Heat deflection temperature was measured using a dynamic mechanical analyzer (DMA) from TA Instruments, USA, with sample bars of 3.3×12.7×65 mm³ in a 3-point bending mode and temperature ramp rate of 2° C./min.

### 3. Results

### 3.1. In-Situ Compatibilized Composites Based on Binary/Ternary Polymer Blends

### 3.1.1. Composites Based on a Binary Blend Matrix

The effect of compatibilization via an in-situ approach is presented in Table 5. The binary blend presented in these examples are based on a combination of a relatively rigid (PLA in this case) and a relatively tough (PBAT in this case) biodegradable polymer. The binary matrix can also be selected from other biodegradable polymers including, but not limited to PHAs, PCL, PBS, PBSA. Each biodegradable polymer may vary in the range of 0.01 to 90% by weight of the whole composite, more preferably in the range of 30 to 70% by weight of the whole composite. Accordingly, two matrices were prepared; one with lower level of tough polymer and another with higher level of tough polymer. In both cases, the major portion of the matrix is the tough biodegradable polymer. In the examples in Table 5, the composites represent hybrid composites/biocomposites with a combination of two types of filler/reinforcing agent, organic (DDG) and inorganic (talc). However, in such composites, the filler/reinforcing agent can also be selected from any combination of filler/reinforcing agents listed in Table 1, from 0.01 to 60 wt. %, more preferably from 5 to 50 wt. %:

The total filler/reinforcing agent content of the composite formulations in Table 5 is kept constant at 25% by weight of the whole composite.

In-situ compatibilizer system includes an anhydride grafting agent (maleic anhydride, MAH, in this case) and a free radical initiator (dicumyl peroxide, DCP, in this case) of the amounts provided in Table 5. However, in such composite formulations, the anhydride grafting agent and the free radical initiator can also be selected from the ones listed in Table 1, in the range of 0.01 to 3% by weight of the whole composite with the grafting agent to initiator ratio of 1:1 to 10:1.

As shown in Table 5, and by comparing composites 1 (without in situ compatibilizer system) and 2 (with in situ compatibilizer system), it can be seen that the addition of in-situ compatibilizer system improved substantially the tensile and flexural properties as well as MFI.

Table 5 also shows the effect of increasing the tough polymer portion in the matrix (composite 3). This is to improve the elongation as well as the impact strength of the material for applications where higher flexibility and toughness are required while tensile and flexural strength and modulus are not limiting factors. As for example, impact strength value of more than 150 J/m was achieved at total filler/reinforcing agent amount of 25% by weight of the whole composite.

TABLE 5
Examples of composites based on binary blend matrices, compatibilized via
in-situ approach

| | | PLA (wt. | MAH (wt. | DCP (wt. | DDG (wt. | |
|---|---|---|---|---|---|---|
| Formulation | PBAT (wt. %) | %) | %) | %) | %) | Talc (wt. %) |
| Composite 1 | 41.25 | 33.75 | — | — | 20 | 5 |
| Composite 2 | 40.7 | 33.3 | 0.91 | 0.09 | 20 | 5 |
| Composite 3 | 52.5 | 22.5 | — | — | 20 | 5 |

| | Tensile | | | Maximum | | | MFI | |
|---|---|---|---|---|---|---|---|---|
| | yield | Tensile | % | Flexural | Flexural | Impact | (g/10 min) | |
| | Strength | Modulus | Elongation | Stress | Modulus | strength | at 190° C./ | HDT |
| Formulation | (MPa) | (MPa) | at break | (MPa) | (MPa) | (J/m) | 2.16 kg | (° C.) |
| Composite 1 | 14 ± 0.5 | 1020 ± 20 | 7 ± 2 | 25 ± 2 | 949 ± 68 | 85 ± 10 | 17 ± 1 | 53 |
| Composite 2 | 16.7 ± 0.1 | 1120 ± 10 | 9.7 ± 1.8 | 31.4 ± 0.2 | 1160 ± 10 | 80 ± 4 | 30 ± 3 | 55 |
| Composite 3 | 10 ± 1 | 450 ± 24 | 18 ± 1 | 15 ± 4 | 550 ± 112 | 155 ± 19 | 17 ± 2 | 51 |

### 3.1.2. Composites Based on a Ternary Blend Matrix

In Table 6, different in-situ compatibilized biocomposites produced from ternary polymer blend matrix are compared. The in-situ compatibilized samples were prepared in the large-scale Leistritz extruder explained in “Methods” section followed by DSM micro-injection molding machine. The uncompatibilized composite counterpart of each in-situ compatibilized formulation was prepared in the small-scale DSM micro-extruder followed by DSM micro-injection molding machine.

The formulations in Table 6 are based on a combination of three biodegradable polymers, PLA, PBAT, and PBS. The ternary matrix can also be selected from other biodegradable polymers including, but not limited to PHAs, PCL, PBSA, each biodegradable polymer in the range of 0.01 to 90% by weight of the whole composite, more preferably in the range of 10 to 60% by weight of the whole composite. Accordingly, three matrices were prepared with similar combination of type and ratio of biodegradable polymers. The difference between different matrices lies on the melting point of the PLA; composite 1 and 2 contain high-melting point PLA and composite 3 and 4 contain low-melting point PLA. Similarly, Matrix 3 was produced from a low-melting point PLA produced by a second manufacturer. An advantage of using a grade of the PLA polymer of low melting point is that the processing temperature can be reduced to decrease the cost of production and to minimize the degradation of biomass. The filler/reinforcing agent and the in-situ compatibilizer system of the examples in Table 6 are exactly similar to that discussed in the previous section.

At first, the difference between binary and ternary blends for the matrix can be realized by comparing formulations in Table 5 versus Table 6, more specifically composite 2 of each table. As observed, addition of a PBS in the matrix resulted in higher strength and modulus in both tensile and flexural tests while the impact strength remained same and the MFI is still in the acceptable range for fast injection molding applications.

The composite formulation with low-melting point grades of PLA generally exhibited slightly lower strength, modulus and MFI, but showed improved impact strength and elongation. As observed from composites 1 to 4 in Table 6, the in-situ compatibilization proved to be effective in improving the adhesion between the filler/reinforcing agents and the matrix by increasing the strength and modulus of the composite material. The elongation, impact strength, and MFI of the in-situ compatibilized formulations either remained unchanged or were reduced compared to their uncompatibilized counterparts, but still in an acceptable range for many injection molded parts.

Composite formulations 5 and 6 in Table 6 show the effect of increasing the amount of in-situ compatibilizer system from 1 to 1.5 wt. %. As a result, higher content of compatibilizer improved all tensile and flexural properties without significantly compromising the impact strength. Moreover, the MFI was improved dramatically suitable for fast injection molding of parts with complex shapes.

TABLE 6
Examples of composites based on ternary blend matrices, compatibilized via
in-situ approach

| | | PBAT | High melting | Low melting | PBS | MAH | DCP | DDG | |
|---|---|---|---|---|---|---|---|---|---|
| | Extrusion | (wt. | point PLA | point PLA | (wt. | (wt. | (wt. | (wt. | Talc |
| Formulation | method | %) | (wt. %), | (wt. %), | %) | %) | %) | %) | (wt. %) |
| Composite 1 | Small scale | 33.75 | 30 | — | 11.25 | — | — | 20 | 5 |
| Composite 2 | Large scale | 33.3 | 29.6 | — | 11.1 | 0.91 | 0.09 | 20 | 5 |
| Composite 3 | Small scale | 33.75 | — | 30 (grade 1) | 11.25 | — | — | 20 | 5 |
| Composite 4 | Large scale | 33.3 | — | 29.6 (grade 1) | 11.1 | 0.91 | 0.09 | 20 | 5 |
| Composite 5 | Large scale | 33.3 | — | 29.6 (grade 2) | 11.1 | 0.91 | 0.09 | 20 | 5 |
| Composite 6 | Large scale | 33.75 | — | 29.4 (grade 2) | 11.025 | 1.36 | 0.14 | 20 | 5 |

| | | | | Maximum | | | MFI | |
|---|---|---|---|---|---|---|---|---|
| | Tensile yield | Tensile | % | Flexural | Flexural | Impact | (g/10 min) | |
| | Strength | Modulus | Elongation | Stress | Modulus | strength | at 190° C./ | HDT |
| Formulation | (MPa) | (MPa) | at break | (MPa) | (MPa) | (J/m) | 2.16 kg | (° C.) |
| Composite 1 | 18.0 ± 0.5 | 1220 ± 30 | 8.0 ± 2.0 | 32 ± 0.5 | 1270 ± 40 | 76 ± 15 | 29 ± 2 | 55 |
| Composite 2 | 20.0 ± 0.1 | 1270 ± 10 | 8.4 ± 1.2 | 38.8 ± 0.2 | 1400 ± 30 | 80 ± 5 | 17.4 ± 2.3 | 56 |
| Composite 3 | 17.0 ± 2.0 | 1060 ± 20 | 14.0 ± 2.0 | 29.0 ± 1.0 | 1050 ± 70 | 117 ± 9 | 16 ± 2 | 55 |
| Composite 4 | 19.9 ± 0.1 | 1200 ± 10 | 9.0 ± 0.5 | 35.8 ± 0.4 | 1300 ± 10 | 98 ± 6 | 14.5 ± 1.6 | 55 |
| Composite 5 | 18.4 ± 0.2 | 1140 ± 20 | 10.2 ± 1.6 | 34.0 ± 0.4 | 1230 ± 10 | 102 ± 5 | 12.4 ± 0.5 | 56 |
| Composite 6 | 19.0 ± 0.2 | 1300 ± 10 | 11.0 ± 1.8 | 35.9 ± 0.5 | 1310 ± 20 | 93 ± 4 | 21.2 ± 1.3 | 56 |

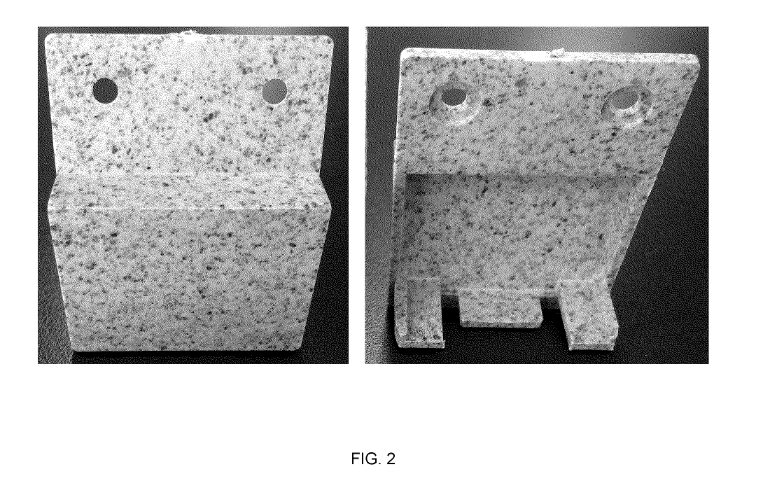

FIG. 2 shows an injection moulded part made of an in-situ compatibilized ternary matrix with 25 wt. % filler/reinforcing agent (DDG and talc).

### 3.2. Composites Compatibilized by a Synthesized Compatibilizer Based on a Single-Polymer, a Binary Polymer Blend, a Ternary Polymer Blend, or a Quaternary Polymer Blend

3.2.1. Composites Based on a Single-Polymer Matrix with Varying Amount of Synthesized Compatibilizer Based on the Single Polymer

In the examples provided in Table 7, it has been tried to demonstrate the advantages of using a synthesized compatibilizer and, at the same time, to highlight the bottleneck of single-polymer matrix composite with synthesized compatibilizer based on the single polymer.

Table 7 shows the performance of PBS-based composites with 30 wt. % of a perennial grass, miscanthus, with and without anhydride grafted compatibilizer based on PBS. In such composites, the filler/reinforcing agent can also be selected from any combination of filler/reinforcing agents listed in Table 1, from 0.01 to 60 wt. %, more preferably from 5 to 50 wt. %.

The compatibilizer amount was increased from 1 to 10% by weight of the whole composite. The tensile modulus of the composites was increased 3-foldwith the addition of 30 wt. % filler/reinforcing agent. However, there was not a significant increase in the modulus of the composites with different levels of compatibilizer. The tensile strength of the uncompatibilized composites was significantly reduced as compared to the neat PBS matrix. On the contrary, a significant improvement of tensile strength is observed with the addition of compatibilizer. This suggests that the compatibilizer is acting as a good adhesion promoter between the filler/reinforcing agent and the matrix. The flexural properties of the composites increased with the addition of filler/reinforcing agent and/or compatibilizer.

The impact strength was improved after addition of the filler/reinforcing agent compared to that of the matrix and was further improved with increasing the compatibilizer. An obvious reduction was observed in the melt flow (MFI) of the composite with the addition of filler/reinforcing agent when compared to its neat PBS matrix. This is expected due to the restriction imposed by the filler/reinforcing agent in mobility of the polymer chains. It was observed that the compatibilizer is capable of tailoring this property to higher values, thus compatibilized composite showed improvement in MFI as compared to uncompatibilized composites. This is an attractive factor in injection molding of parts made from such composite formulations. The heat deflection temperature (HDT) of the uncompatibilized composite is considerably improved compared to that of neat PBS, and further improved as a result of compatibilization up to temperatures very close to the melting point of PBS (115° C.).

TABLE 7
The change in compatibilizer amount and mechanical properties of examples
of composites based on varying amount of PBS matrix and 30 wt. % filler/reinforcing
agent, compatibilized with different amounts of PBS-based synthesized compatibilizer

| | PBS | | |
|---|---|---|---|
| Formulations | (wt. %) | PBS based compatibilizer | Miscanthus (wt. %) |
| PBS matrix | 100 | — | — |
| Composite 1 | 70 | — | 30 |
| Composite 2 | 69 | 1 | 30 |
| Composite 3 | 67 | 3 | 30 |
| Composite 4 | 65 | 5 | 30 |
| Composite 5 | 60 | 10 | 30 |

| | | | | | | | MFI | |
|---|---|---|---|---|---|---|---|---|
| Formulations | Tensile | Tensile | Elongation | Flexural | Flexural | Impact | (g/10 min) | |
| Processed in | strength | Modulus | at break | Strength | Modulus | strength | at 190° C./ | HDT |
| DSM | (MPa) | (MPa) | (%) | (MPa) | (MPa) | (J/m) | 2.16 kg | (° C.) |
| PBS matrix | 39.4 ± 0.7 | 640 ± 10 | 246 ± 10 | 33.2 ± 1.0 | 760 ± 30 | 28.4 ± 0.9 | 22.2 ± 1.8 | 93 |
| Composite 1 | 33.2 ± 1.7 | 2210 ± 80 | 3.8 ± 0.6 | 55.0 ± 1.3 | 2380 ± 50 | 46.4 ± 1.4 | 7.8 ± 1.1 | 106 |
| Composite 2 | 36.2 ± 0.9 | 2390 ± 60 | 3.4 ± 0.2 | 61.3 ± 2.2 | 2630 ± 80 | 46.2 ± 1.5 | 11.0 ± 2.3 | 114 |
| Composite 3 | 41.3 ± 1.5 | 2180 ± 120 | 3.7 ± 0.2 | 73.6 ± 1.8 | 2280 ± 100 | 47.50 ± 4.8 | 8.9 ± 1.0 | 108 |
| Composite 4 | 44.4 ± 2.0 | 2300 ± 90 | 3.7 ± 0.3 | 75.3 ± 2.4 | 2350 ± 100 | 53.2 ± 3.5 | 10.9 ± 1.2 | 112 |
| Composite 5 | 45.3 ± 1.6 | 2210 ± 50 | 4.0 ± 0.3 | 75.5 ± 2.0 | 2350 ± 210 | 52.4 ± 1.2 | 11.9 ± 1.4 | 111 |

3.2.2. Composites Based on a Binary Polymer Blend Matrix with Varying Amounts of Filler/Reinforcing Agent and Varying Amounts of Synthesized Compatibilizer Based on the Binary Polymer Blend

In these examples, the bioscomposites containing up to 50% filler/reinforcing agent with acceptable properties are disclosed. The formulations and properties of PBS-PBAT blend and their composites with miscanthus are presented in Table 8. The filler/reinforcing agent can also be selected from any combination of filler/reinforcing agents listed in Table 1, from 0.01 to 60 wt. %, more preferably from 5 to 50 wt. %.

The idea of using a binary blend matrix is to balance the tensile and flexural strengths and moduli, flexibility and toughness. The amount of filler/reinforcing agent varies within the range of 30 to 50 wt. %. The anhydride grafted PBS-PBAT blend was used as a compatibilizer in order to improve the compatibility between the fiber and the matrix, within the range of 0 to 11 wt. %.

It can be seen that all the composites showed a higher tensile modulus than the PBS-PBAT blend. The tensile modulus of the composites gradually increased with increasing fiber content. However, the tensile strength of composites is drastically decreased with increase in fiber content.

All the compatibilized composites showed a noticeable improvement in tensile properties in comparison to their corresponding uncompatibilized composites. The improvements were likely due to the enhanced interfacial adhesion between the fiber and the matrix. For instance, incorporation of compatibilizer at 5 wt. % into the composite with 50 wt. % of filler/reinforcing agent, showed 70% tensile strength and 19% tensile modulus improvement when compared to their corresponding uncompatibilized composites.

Table 8 also illustrates the influence of filler/reinforcing agent content on the flexural properties of PBS-PBAT based composites with and without compatibilizer. Similar to tensile modulus, the addition of filler/reinforcing agent into PBS-PBAT blend led to a remarkable improvement in flexural modulus. The compatibilized composites showed a slight improvement in flexural modulus compared with their corresponding uncompatibilized composites. This indicates that the compatibilizer may reduce the fiber agglomeration in the resulting biocomposites. In addition, the flexural strength of the uncompatiblized composites was reduced with varying percentage of filler/reinforcing agent content from 30 to 50 wt. %. Interestingly, the flexural strength of the uncompatibilized composites was still superior to that of the PBS-PBAT blend matrix. Considering the amount of compatibilizer at 5 wt. %, the compatibilized composite with 50 wt. % of filler/reinforcing agent exhibited the highest flexural strength and modulus, improved approximately 190% and 520%, respectively, compared with PBS-PBAT matrix.

The results in Table 8 also represent the notched Izod impact strength of compatibilized and uncompatibilized PBS-PBAT blend based composites as a function of compatibilizer and filler/reinforcing agent loading. Non-break impact strength was observed in the PBS-PBAT blend. The addition of filler/reinforcing agent fibers into PBS-PBAT blend matrix resulted in a significant reduction in impact strength. This is because the failure mode of PBS-PBAT blend changed from ductile to brittle fracture in the presence of filler/reinforcing agent. However, the impact strength was increased considerably by the addition of compatibilizer into the composites. The compatibilized (5 wt. %) composites with 30, 40, and 50 wt. % of filler/reinforcing agent showed 44, 44 and 36% improvement in impact strength when compared to their corresponding uncompatibilized composites, respectively. Overall, the observed mechanical properties of the compatibilized PBS-PBAT matrix based composites suggest that the compatibility between the fiber-matrix has been greatly improved.

The heat deflection temperature (HDT) values of the PBS-PBAT blend and its composites are also shown in Table 8. All the composites have higher HDT than PBS-PBAT blend. The HDT values of the composites with 30, 40, and 50 wt. % of filler/reinforcing agent were around 99, 99 and 105° C., respectively. Only a marginal improvement was observed while increasing the filler/reinforcing agent content. This could be due to the fact that HDT values of the composites are very close to the melting point (115° C.) of the PBS-PBAT blend. The HDT values of the compatibilized composites were not significantly changed as compared to their corresponding uncompatibilized composites.

An obvious reduction was observed in the melt flow (MFI) of the composites when compared to its neat PBS matrix. The compatibilized composite showed slight improvement in MFI as compared to uncompatibilized composites.

In another set of experiments, the amount of compatibilizer was increased from 0 to 11 wt. %, keeping the amount of filler/reinforcing agent constant at 50 wt. %. As observed in Table 8, all properties of the composite showed an increasing trend or no-change behavior with increasing the amount of compatibilizer, with no exception.

The results presented in Table 8 demonstrate the capability of tailoring different mechanical and physical properties of the composite with changing the amount of compatibilizer and/or the filler/reinforcing agent. For example, formulations of high content of filler/reinforcing agent have been developed still with melt flow characteristics acceptable for many small to medium sized injection molded part, exhibiting at the same time a good balance of mechanical properties.

TABLE 8
The change in compatibilizer amount, the filler/reinforcing agent amount, and
mechanical properties of examples of composites based on binary blend matrix of PBS
and PBAT, compatibilized with a synthesized compatibilizer based on the binary blend

| | | | PBS/PBAT based | |
|---|---|---|---|---|
| | | | compatibilizer | |
| Formulations | PBS (wt. %) | PBAT (wt. %) | (wt. %) | Miscanthus (wt. %) |
| PBS-PBAT | 60 | 40 | — | — |
| matrix | | | | |
| Composite 1 | 42 | 28 | — | 30 |
| Composite 2 | 39 | 26 | 5 | 30 |
| Composite 3 | 36 | 24 | — | 40 |
| Composite 4 | 33 | 22 | 5 | 40 |
| Composite 5 | 30 | 20 | — | 50 |
| Composite 6 | 27 | 18 | 5 | 50 |
| Composite 7 | 25.8 | 17.2 | 7 | 50 |
| Composite 8 | 24.6 | 16.4 | 9 | 50 |
| Composite 9 | 23.4 | 15.6 | 11 | 50 |

| | | | | | | | MFI | |
|---|---|---|---|---|---|---|---|---|
| | Tensile | Tensile | Elongation | Flexural | Flexural | Impact | (g/10 min) | |
| | strength | Modulus | at break | Strength | Modulus | strength | at | HDT |
| Formulations | (MPa) | (MPa) | (%) | (MPa) | (MPa) | (J/m) | 190° C., 2.16 kg | (° C.) |
| PBS-PBAT | 32.9 ± 1.24 | 355 ± 10 | 339 ± 38.7 | 17.1 ± 0.3 | 380 ± 10 | Non- | 33.3 ± 2.8 | 71 |
| matrix | | | | | | break | | |
| Composite 1 | 20.0 ± 0.42 | 1350 ± 70 | 5.1 ± 0.4 | 36.2 ± 0.4 | 1460 ± 30 | 64.5 ± 3.6 | 12.7 ± 1.5 | 99 |
| Composite 2 | 26.8 ± 0.62 | 1330 ± 30 | 5.6 ± 0.3 | 40.0 ± 0.8 | 1380 ± 50 | 93.0 ± 5.5 | 10.0 ± 1.1 | 96 |
| Composite 3 | 20.9 ± 0.25 | 1710 ± 80 | 4.0 ± 0.4 | 35.1 ± 0.4 | 1770 ± 140 | 54.4 ± 2.9 | 3.9 ± 0.6 | 101 |
| Composite 4 | 27.4 ± 0.51 | 1860 ± 60 | 3.5 ± 0.3 | 44.3 ± 0.5 | 1830 ± 60 | 78.6 ± 3.7 | 7.0 ± 1.2 | 106 |
| Composite 5 | 17.4 ± 0.93 | 2060 ± 230 | 2.8 ± 0.2 | 31.2 ± 1.2 | 2200 ± 140 | 46.6 ± 1.6 | <2 | 106 |
| Composite 6 | 29.5 ± 0.98 | 2450 ± 160 | 2.9 ± 0.1 | 50.1 ± 0.9 | 2360 ± 180 | 63.4 ± 3.1 | 4.6 ± 1.0 | 105 |
| Composite 7 | 31.4 ± 1.0 | 2510 ± 160 | 3.2 ± 0.4 | 53.0 ± 3.3 | 2440 ± 370 | 74.7 ± 2.3 | 4.8 ± 0.6 | 108 |
| Composite 8 | 32.8 ± 0.6 | 2580 ± 50 | 3.1 ± 0.2 | 54.2 ± 1.1 | 2780 ± 260 | 68.7 ± 3.6 | 5.4 ± 0.9 | 110 |
| Composite 9 | 30.7 ± 0.4 | 2460 ± 60 | 3.0 ± 0.2 | 54.4 ± 0.9 | 2630 ± 80 | 64.1 ± 2.1 | 5.2 ± 0.7 | 106 |

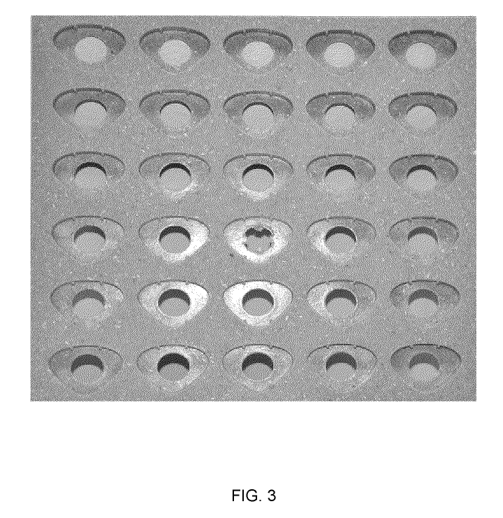

FIG. 3 illustrates an example of an injection molded part manufactured with a binary matrix, 30% miscanthus compatibilized with a binary compatibilizer.

3.2.3. Composites Based on Ternary Polymer Blend Matrices with Varying Amounts of Filler/Reinforcing Agent and Varying Amounts of Synthesized Compatibilizer Based on the Binary or Ternary Polymer Blend

The ternary blends presented in the example composites 1 to 5 in Table 9 are based on a combination of three biodegradable polymers, from PLA, PBAT, PBS. However, the matrix polymers may also be selected from other biodegradable polymers including but not limited to PHA family and/or PCL, each biodegradable polymer in the range of 0.01 to 90% by weight of the whole composite, more preferably in the range of 10 to 60% by weight of the whole composite.

The ternary blends presented in the example composites 6 to 9 in Table 9 are based on a combination of three biodegradable polymers, from PLA, PHBV, PBS. However, the matrix polymers may also be selected from other biodegradable polymers including but not limited to PBAT and/or PCL, each biodegradable polymer in the range of 0.01 to 90% by weight of the whole composite, more preferably in the range of 10 to 60% by weight of the whole composite.

In the examples presented in Table 9, the selected filler/reinforcing agents are coffee chaff, water-washed DDGS (ww-DDGS), bleached DDGS, corn kernel fibre and miscanthus. In some of the examples in Table 9, the composites represent hybrid composites/biocomposites with a biomass hybrid of coffee chaff and miscanthus, or coffee chaff and ww-DDGS. In such composites, the filler/reinforcing agent can also be selected from any combination of filler/reinforcing agents listed in Table 1, from 0.01 to 60 wt. %, more preferably from 5 to 50 wt. %.

The composites were compatibilized with 3 wt. % of a binary or ternary compatibilizer, synthesized through the method explained previously. In such composites, the composites may also be compatibilized with a binary or ternary compatibilizer in the range of 0.01 to 15% by weight of the whole composite, more preferably in the range of 2 to 9% by weight of the whole composite.

In the example composites 7 to 9 presented in Table 9, the selected plasticizer is tributyl citrate (TBC). However, the plasticizer may also be selected from other alkyl citrates or other polymer plasticizers, added in the range of 0.01 to 10% by weight of the whole composite, more preferably in the range of 2 to 9% by weight of the whole composite.

In Table 9, some examples of single or hybridized filler composites based on a ternary polymer blend matrix and synthesized compatibilizer based on binary or ternary polymer blends are provided. The results show that with the addition of different combinations of filler/reinforcing agents and the binary or ternary blend based compatibilizer, a stronger (higher tensile and flexural strength, higher HDT) and less flexible (lower elongation-at-break and impact strength) can be obtained.

Composites 1 to 3 in Table 9 are examples of formulations with single filler. Composite formulations 4 and 5 demonstrate the samples with a biomass hybrid. The idea behind hybridization is to improve the rigidity at room temperature (tensile and flexural modulus) and rigidity at elevated temperatures (HDT). Thus, coffee chaff of low cellulosic content was combined with miscanthus of high cellulosic content. It is observed that in the formulations containing miscanthus, both tensile and flexural strengths and moduli were increased. At the same time the HDT was improved and impact was maintained at an acceptable level. Exchanging the compatibilizer type from a binary blend based (composite 4) to a ternary blend based (composite 5) tailored the melt flow behaviour with even higher HDT, tensile and flexural strengths and moduli, and lower elongation and impact strength.

The effect of plasticizer is shown in example composites 6 and 7. Composite 7 containing the plasticizer showed less strength, modulus and HDT, but exhibited improved elongation and impact strength compared to composite 6 with no plasticizer. The hybridization of the fillers, ww-DDGS and coffee chaff, in composite 8 did not significantly changed the properties compared to composite 7 containing only ww-DDGS as the filler. The composite 9 containing corn kernel fibre was tailored to have more filler content than composites 7 and 8, but with similar elongation and higher HDT, i.e. rigidity at higher temperatures.

Among all examples presented in Table 9, an outstanding feature of composite 3 containing bleached DDGS and composite 8 containing corn kernel fibre was the significantly lower odor of biomass remained with the injected samples of those two composite formulations after processing. Similar feature was observed for a composite formulation containing bleached coffee chaff.

TABLE 9
The change in compatibilizer type, the filler/reinforcing agent type and
amount, and mechanical and physical properties of examples of hybridized composites
based on ternary polymer blend matrices, compatibilized with synthesized
compatibilizer based on binary and ternary blends

| | Ternary | Binary blend | Ternary blend | | | | | Corn | |
|---|---|---|---|---|---|---|---|---|---|
| | blend based | based | based | Coffee | | ww- | Bleached | kernel | |
| | matrix | compatibilizer | compatibilizer | chaff | Miscanthus | DDGS | DDGS | fibre | Plasticizer |
| Formulation | (wt. %) | (wt. %) | (wt. %) | (wt. %) | (wt. %) | (wt. %) | (wt. %) | (wt. %) | (wt. %) |
| Composite 1 | 80 | — | — | 20 | — | — | — | — | — |
| Composite 2 | 77 | — | 3 | — | — | 20 | — | — | — |
| Composite 3 | 74 | — | 3 | — | — | — | 23 | — | — |
| Composite 4 | 77 | 3 | — | 10 | 10 | — | — | — | — |
| Composite 5 | 77 | — | 3 | 10 | 10 | — | — | — | — |
| Composite 6 | 67 | 3 | — | — | — | 30 | — | — | — |
| Composite 7 | 67 | 3 | — | — | — | 25 | — | — | 5 |
| Composite 8 | 67 | 3 | — | 5 | — | 20 | — | — | 5 |
| Composite 9 | 62 | — | 3 | — | — | — | — | 30 | 5 |

| | Tensile | | | | Max. | | | MFI | |
|---|---|---|---|---|---|---|---|---|---|
| | yield | Tensile | | | Flexural | Flexural | Impact | (g/10 min) | |
| | Strength | Modulus | % Elongation | % Elongation | Stress | Modulus | strength | at 190° C., | HDT |
| Formulation | (MPa) | (MPa) | at Yield | at break | (MPa) | (MPa) | (J/m) | 2.16 kg | (° C.) |
| Composite 1 | 23.4 ± 0.5 | 1170 ± 20 | 6.5 ± 0.3 | 20.9 ± 2.7 | 37.0 ± 2.3 | 1390 ± 40 | 85.4 ± 3.1 | 15.6 ± 0.6 | 68 |
| Composite 2 | 21.5 ± 0.4 | 810 ± 40 | 8.8 ± 0.9 | 15.0 ± 1.7 | 31.0 ± 0.5 | 890 ± 20 | 107 ± 11 | 14.8 ± 0.2 | 56 |
| Composite 3 | 18.8 ± 0.7 | 850 ± 30 | 7.9 ± 0.5 | 16.2 ± 1.8 | 27.7 ± 0.6 | 870 ± 30 | 106.8 ± 8.1 | 21.0 ± 0.1 | 60 |
| Composite 4 | 30.2 ± 0.3 | 1400 ± 40 | 6.7 ± 0.2 | 9.8 ± 1.4 | 44.6 ± 0.8 | 1430 ± 50 | 91.8 ± 9.4 | 7.2 ± 0.2 | 85 |
| Composite 5 | 32.7 ± 0.8 | 1450 ± 60 | 5.9 ± 0.4 | 7.4 ± 1.0 | 45.1 ± 1.6 | 1540 ± 70 | 75.9 ± 3.7 | 12.3 ± 0.3 | 92 |
| Composite 6 | 29.3 ± 0.5 | 2540 ± 50 | — | 2.0 ± 0.3 | 48.4 ± 1.2 | 3020 ± 40 | 13.9 ± 1.0 | 34.3 ± 1.5 | 132 |
| Composite 7 | 25.3 ± 1.0 | 1720 ± 50 | 3.0 ± 0.2 | 4.3 ± 0.4 | 41.5 ± 1.9 | 1890 ± 120 | 30.7 ± 1.9 | 22.7 ± 0.7 | 77 |
| Composite 8 | 25.5 ± 1.7 | 1790 ± 70 | 2.9 ± 0.1 | 4.0 ± 0.4 | 43.6 ± 1.2 | 2010 ± 100 | 29.9 ± 0.8 | 22.7 ± 2.4 | 84 |
| Composite 9 | 20.2 ± 1.1 | 1460 ± 110 | 3.4 ± 0.2 | 3.9 ± 0.4 | 35.7 ± 2.1 | 1610 ± 100 | 30.7 ± 0.8 | 21.1 ± 1.7 | 94 |

3.2.4. Composites Based on Quaternary Polymer Blend Matrices with Filler/Reinforcing Agent and Varying Amount of Synthesized Compatibilizer Based on the Quaternary Polymer Blend

The quaternary blends presented in the examples in Table 10 are based on a combination of four biodegradable polymers, from PHBV, PLA, PBAT, PBS. However, the matrix polymers may also be selected from other biodegradable polymers including PHA family and/or PCL, each biodegradable polymer in the range of 0.01 to 90% by weight of the whole composite, more preferably in the range of 10 to 60% by weight of the whole composite. In the examples presented in Table 10, the selected filler/reinforcing agents are water-washed DDGS (ww-DDGS) and corn stalk. In such composites, the filler/reinforcing agent can also be selected from any combination of filler/reinforcing agents listed in Table 1, from 0.01 to 60 wt. %, more preferably from 5 to 50 wt. %.

The composites were compatibilized with 3 or 5 wt. % of a quaternary compatibilizer, synthesized through the method explained previously. In such composites, the composites may also be compatibilized with a binary or ternary compatibilizer in the range of 0.01 to 15% by weight of the whole composite, more preferably in the range of 2 to 9% by weight of the whole composite.

In the example composites 5 presented in Table 10, the selected plasticizer is tributyl citrate (TBC). However, the plasticizer may also be selected from other alkyl citrates or other polymer plasticizers, added in the range of 0.01 to 10% by weight of the whole composite, more preferably in the range of 2 to 9% by weight of the whole composite.

The results in Table 10 show that with the addition of the quaternary compatibilizer, a stronger (higher tensile and flexural strength, higher HDT) and less flexible (lower elongation-at-break and impact strength) can be obtained in comparison to the uncompatibilized composite formulation. Furthermore, a direct comparison of ww-DDGS and corn stalk as fillers is obtained from composite 2 and composite 4. The composite 4 with corn stalk was generally stronger (higher strength, modulus and HDT) but less flexible (lower elongation) than the composite 2 with ww-DDGS. The effect of plasticizer is also observed by comparing composite 4 and composite 5. The plasticizer, at the level added in this example, improved the MFI and elongation of corn stalk composite to some extent.

TABLE 10
The change in compatibilizer amount, and mechanical and physical
properties of examples of composites based on quaternary polymer blend matrix,
compatibilized with synthesized compatibilizer based on quaternary blend

| | Quaternary blend | Quaternary blend | | | |
|---|---|---|---|---|---|
| | based matrix | based compatibilizer | ww-DDGS | Corn stalk | Plasticizer |
| Formulation | (wt. %) | (wt. %) | (wt. %) | (wt. %) | (wt. %) |
| Polymeric | 100 | — | — | — | — |
| matrix | | | | | |
| Composite 1 | 70 | — | 30 | — | — |
| Composite 2 | 67 | 3 | 30 | — | — |
| Composite 3 | 65 | 5 | 30 | — | — |
| Composite 4 | 67 | 3 | — | 30 | — |
| Composite 5 | 62 | 3 | — | 30 | 5 |

| | Tensile | | | | Max. | | | MFI | |
|---|---|---|---|---|---|---|---|---|---|
| | yield | Tensile | % | % | Flexural | Flexural | Impact | (g/10 min) | |
| | Strength | Modulus | Elongation | Elongation | Stress | Modulus | strength | at 190° C., | HDT |
| Formulation | (MPa) | (MPa) | at Yield | at break | (MPa) | (MPa) | (J/m) | 2.16 kg | (° C.) |
| Polymeric | 40.3 ± 0.6 | 1270 ± 50 | 8.1 ± 0.6 | 332.0 ± 8.8 | 37.6 ± 1.1 | 1030 ± 40 | 415.6 ± 31.8 | 11.4 ± 0.3 | 64.3 |
| matrix | | | | | | | | | |
| Composite 1 | 16.1 ± 1.9 | 1420 ± 170 | 3.2 ± 0.2 | 7.7 ± 1.7 | 29.4 ± 1.3 | 1190 ± 140 | 47.3 ± 2.8 | 16.1 ± 1.1 | 83.2 |
| Composite 2 | 23.1 ± 0.1 | 1570 ± 20 | 4.9 ± 0.2 | 5.9 ± 0.2 | 36.7 ± 1.1 | 1220 ± 70 | 41.9 ± 6.9 | 17.7 ± 0.4 | 87.3 |
| Composite 3 | 23.3 ± 1.0 | 1580 ± 130 | 4.0 ± 0.3 | 5.9 ± 0.6 | 36.7 ± 1.6 | 1150 ± 40 | 45.7 ± 4.1 | 13.5 ± 0.5 | 86.7 |
| Composite 4 | 34.4 ± 0.7 | 2330 ± 60 | 3.1 ± 0.2 | 3.3 ± 0.2 | 57.3 ± 0.4 | 2720 ± 80 | 48.2 ± 1.5 | 3.7 ± 0.4 | 104 |
| Composite 5 | 28.7 ± 1.1 | 2110 ± 90 | 3.3 ± 0.2 | 3.6 ± 0.3 | 49.0 ± 1.6 | 2330 ± 100 | 51.3 ± 1.6 | 5.0 ± 0.2 | 105 |

### 3.3. Comparison of Composites Compatibilized Via a Synthesized Compatibilizer, or a Chain Extender, or an In-Situ Compatibilization Method

The ternary blends presented in the examples in Table 11 are based on a combination of three biodegradable polymers, from PLA, PBAT, PBS with a fixed ratio between the individual polymers and a fixed overall polymer content in all composite formulations. However, the matrix polymers may also be selected from other biodegradable polymers including but not limited to PHA family and/or PCL, each biodegradable polymer in the range of 0.01 to 90% by weight of the whole composite, more preferably in the range of 10 to 60% by weight of the whole composite. In the composite examples presented in Table 11, the selected filler/reinforcing agents is coffee chaff with a fixed amount in all formulations. In such composites, the filler/reinforcing agent can also be selected from any combination of filler/reinforcing agents listed in Table 1, from 0.01 to 60 wt. %, more preferably from 5 to 50 wt. %.

The composites were compatibilized in utilizing (i) a ternary compatibilizer, synthesized through the method explained previously, (ii) a glycidyl methacrylate (GMA) derived polyepoxide polymer chain extender, Joncryl® from BASF, and (iii) in-situ compatibilization method. In such composites, the composites may also be compatibilized with a binary or ternary compatibilizer in the range of 0.01 to 15% by weight of the whole composite, more preferably in the range of 2 to 9% by weight of the whole composite. Also, the composites may be compatibilized with a polymer chain extender in the range of 0.01 to 5% by weight of the whole composite, more preferably 0.1 to 2% by weight of the whole composite. Also, the composite may be compatibilized via in-situ compatibilization method, as described previously in section 2.1. Also, the composites may be compatibilized with a combination of both synthesized compatibilizer and polymer chain extender. Also, the composites may be compatibilized using polymer chain extender in an in-situ compatibilization method with a free radical initiator and a grafting agent, as described in section 2.1.

In Table 11, the results show that with the addition of coffee chaff with no compatibilizer, all mechanical properties reduced compared to the polymer matrix, except the modulus and HDT. All compatibilized composite formulations in Table 11 showed improvement in the tensile and flexural strength compared to uncompatibilized counterpart, with the best strength obtained by synthesized compatibilizer. On the other hand, the composite 2 compatibilized with Joncryl® exhibited the best elongation-at-break and impact strength among all compatibilized composites in Table 11.

TABLE 11
The change in compatibilizer type, and mechanical and physical properties
of examples of composites based on ternary polymer blend matrices, compatibilized via
different methods

| Formulation | Description |
|---|---|
| Polymer matrix | Ternary polymeric matrix |
| Composite 1 | Ternary polymeric matrix with coffee chaff |
| Composite 2 | Ternary polymeric matrix with coffee chaff compatibilized with Joncryl ® |
| Composite 3 | Ternary polymeric matrix with coffee chaff compatibilized via in-situ method |
| Composite 4 | Ternary polymeric matrix with coffee chaff compatibilized with synthesized compatibilizer |

| | Tensile | | | | Max. | | | MFI | |
|---|---|---|---|---|---|---|---|---|---|
| | yield | Tensile | % | % | Flexural | Flexural | Impact | (g/10 min) | |
| | Strength | Modulus | Elongation | Elongation | Stress | Modulus | strength | at 190° C., | HDT |
| Formulation | (MPa) | (MPa) | at Yield | at break | (MPa) | (MPa) | (J/m) | 2.16 kg | (° C.) |
| Polymer | 23.6 ± 0.3 | 700 ± 30 | 13.8 ± 0.6 | 408 ± 15 | 30.3 ± 1.4 | 790 ± 40 | 668 ± 22 | 8.5 ± 0.1 | 53.0 |
| matrix | | | | | | | | | |
| Composite 1 | 19.8 ± 0.1 | 1240 ± 10 | 6.2 ± 0.2 | 26.7 ± 3.5 | 33.2 ± 0.6 | 1280 ± 20 | 90.4 ± 4.5 | 8.7 ± 0.4 | 69.9 |
| Composite 2 | 21.2 ± 0.7 | 1120 ± 30 | 6.9 ± 0.5 | 15.3 ± 3.7 | 32.2 ± 0.9 | 1170 ± 30 | 71.2 ± 5.9 | 8.9 ± 0.4 | 69.0 |
| Composite 3 | 25.0 ± 0.1 | 1040 ± 10 | 6.8 ± 0.1 | 9.3 ± 0.8 | 36.5 ± 0.1 | 1140 ± 10 | 57.0 ± 3.2 | 9.0 ± 0.1 | 68.8 |
| Composite 4 | 28.7 ± 0.2 | 1250 ± 20 | 6.7 ± 0.1 | 10.9 ± 1.1 | 42.8 ± 0.3 | 1340 ± 10 | 63.0 ± 1.9 | 8.1 ± 0.3 | 78.5 |

### REFERENCES

[1] OECD-FAO Agricultural Outlook 2011: Organisation for Economic Co-operation and Development; 2011 (DOI: 10.1787/agr_outlook-2011-en).
[2] Zarrinbakhsh N, Mohanty A K, Misra M. Fundamental studies on water-washing of the corn ethanol coproduct (DDGS) and its characterization for biocomposite applications. Biomass and Bioenergy. 2013; 55, 251-9.
[3] Zarrinbakhsh N, Misra M, Mohanty A K. Biodegradable green composites from distiller's dried grains with solubles (DDGS) and polyhydroxy(butyrate-co-valerate) (PHBV)-based bioplastic. Macromolecular Materials and Engineering. 2011; 296: 1035-45.
[4] Julson J L, Subbarao G, Stokke D D, Gieselman H H, Muthukumarappan K. Mechanical properties of biorenewable fiber/plastic composites. Journal of Applied Polymer Science. 2004; 93: 2484-93.
[5] Tisserat B H, Reifschneider L, O'Kuru R H, Finkenstadt V L. Mechanical and thermal properties of high density polyethylene-dried distillers grains with solubles composites. BioResources. 2013; 8: 59-75.
[6] Chevali V S, Nerenz B A, Ulven C A. Acrylonitrile Butadiene Styrene (ABS)/Lignocellulosic fiber biocomposite: effect of artificial weathering on impact properties. Journal of Biobased Materials and Bioenergy. 2012; 6: 42-50.
[7] Wu Q, Mohanty A K. Renewable resource based biocomposites from coproduct of dry milling corn ethanol industry and castor oil based biopolyurethanes. Journal of Biobased Materials and Bioenergy. 2007; 1: 257-65.
[8] Tatara R A, Suraparaju S, Rosentrater K A. Compression molding of phenolic resin and corn-based DDGS blends. Journal of Polymers and the Environment. 2007; 15: 89-95.
[9] Tatara R A, Rosentrater K A, Suraparaju S. Design properties for molded, corn-based DDGS-filled phenolic resin. Industrial Crops and Products. 2009; 29: 9-15.
[10] Cheesbrough V, Rosentrater K A, Visser J. Properties of Distillers Grains Composites: A Preliminary Investigation. Journal of Polymers and the Environment. 2008; 16: 40-50.
[11] Li Y, Susan Sun X. Mechanical and thermal properties of biocomposites from poly(lactic acid) and DDGS. Journal of Applied Polymer Science 2011; 121: 589-97.
[12] Clarizio S, Tatara R. Tensile strength, elongation, hardness, and tensile and flexural moduli of pla filled with glycerol-plasticized DDGS. Journal of Polymers and the Environment 2012; 20: 638-646.
[13] Zarrinbakhsh N, Mohanty A K, Misra M, Improving the interfacial adhesion in a new renewable resource-based biocomposites from biofuel coproduct and biodegradable plastic. Journal of Materials Science. 2013; 48, 6025-38.
[14] Zarrinbakhsh N, Defersha F M, Mohanty A K, Misra M, A statistical approach to engineer a biocomposite formulation from biofuel coproduct with balanced properties. Journal of Applied Polymer Science. 2014; 131, 40443 DOI: 10.1002/app.40443.
[15] Muniyasamy S, Reddy M M, Misra M, Mohanty A K. Biodegradable Green Composites from Bioethanol Co-product and Poly(Butylene Adipate-co-Terephatalate). Industrial Crops and Products 2013; 43: 812-9.
[16] Mussatto S I, Machado E M S, Martins S, Teixeira J A, Production, composition, and application of coffee and its industrial residues. Food and Bioprocess Technology. 2011; 4(5), 661-672.
[17] Saenger M, Hartge E-U, Werther J, Ogada T, Siagi Z, Combustion of coffee husks. Renewable Energy. 2001; 23, 103-121.
[18] Pourfarzad A, Mandavian-Mehr H, Sedaghat N, Coffee silverskin as a source of dietary fiber in bread-making: Optimization of chemical treatment using response surface methodology. LWT-Food Science and Technology. 2013; 50(2), 599-606.
[19] Borrelli R C, Esposito F, Napolitano A, Ritieni A, Fogliano V, Characterization of a new potential functional ingredient: coffee silverskin. Journal of Agricultural and Food Chemistry. 2004; 52(5), 1338-1343.
[20] Narita Y, Inouye K, High antioxidant activity of coffee silverskin extracts obtained by the treatment of coffee silverskin with subcritical water. Food Chemistry. 2012; 135(3), 943-949.
[21] Barone J R, Lignocellulosic Fiber-Reinforced Keratin Polymer Composites. Journal of Polymers and the Environment. 2009; 17 (2), 143-151.
[22] Satyanarayana K G, Arizaga G G C, Wypych F, Biodegradable composites based on lignocellulosic fibers—An overview. Progress in Polymer Science. 2009; 34(9), 982-1021.
[23] Bourmaud A, Pimbert S, Investigations on mechanical properties of poly(propylene) and poly(lactic acid) reinforced by miscanthus fibers. Composites Part A: Applied Science and Manufacturing. 2008; 39(9), 1444-54.
[24] Mohanty A K, Misra M, Hinrichsen G, Biofibres, biodegradable polymers and biocomposites: An overview. Macromolecular Materials and Engineering. 2000; 276-277(1), 1-24.
[25] Kim H-S, Kim S, Kim H-J, Yang H-S, Thermal properties of bio-flour-filled polyolefin composites with different compatibilizing agent type and content. Thermochimica Acta. 2006; 451(1-2), 181-8.
[26] Tserki V, Matzinos P, Panayiotou C, Effect of compatibilization on the performance of biodegradable composites using cotton fiber waste as filler. Journal of Applied Polymer Science. 2003; 88(7), 1825-35.
[27] Kim H-S, Lee B-H, Lee S, Kim H-J, Dorgan J R, Enhanced interfacial adhesion, mechanical, and thermal properties of natural flour-filled biodegradable polymer bio-composites. Journal of Thermal Analysis and calorimetry. 2011; 104(1), 331-8.
[28] Avella M, Bogoeva-Gaceva G, Bužarovska A, Errico M E, Gentile G, Grozdanov A, Poly(3-hydroxybutyrate-co-3-hydroxyvalerate)-based biocomposites reinforced with kenaf fibers. Journal of Applied Polymer Science. 2007; 104(5), 3192-3200.
[29] Thirmizir M Z A, Mohd Ishak Z A, Taib R M, Rahim S, Mohamad Jani S, Kenaf-bast-fiber-filled biodegradable poly(butylene succinate) composites: Effects of fiber loading, fiber length, and maleated poly(butylene succinate) on the flexural and impact properties. Journal of Applied Polymer Science. 2011; 122(5), 3055-63.
[30] Lee J M, Mohd Ishak Z A, Mat Taib R, Law T T, Ahmad Thirmizir M Z, Mechanical, Thermal and Water Absorption Properties of Kenaf-Fiber-Based Polypropylene and Poly(Butylene Succinate) Composites. Journal of Polymers and the Environment. 2013; 21(1), 293-302.
[31] Roeder J., Oliveira R V B, Gonçalves M C, Soldi V, Pires A T N, Polypropylene/polyamide-6 blends: influence of compatibilizing agent on interface domains. Polymer Testing. 2002; 21(7), 815-21.
[32] Kim H-S, Lee B-H, Choi S-W, Kim S, Kim H-J, The effect of types of maleic anhydride-grafted polypropylene (MAPP) on the interfacial adhesion properties of bio-flour-filled polypropylene composites. Composites Part A: Applied Science and Manufacturing. 2007; 38(6), 1473-82.
[33] Avella M, Bogoeva-Gaceva G, Bužarovska A, Errico M E, Gentile G, Grozdanov A, Poly(lactic acid)-based biocomposites reinforced with kenaf fibers. Journal of Applied Polymer Science. 2008; 108(6), 3542-51.
[34] Nabar Y, Raquez J M, Dubois P, Narayan R, Production of starch foams by twin-screw extrusion: effect of maleated poly(butylene adipate-co-terephthalate) as a compatibilizer. Biomacromolecules. 2005; 6(2), 807-17.
[35] Phua Y J, Lau N S, Sudesh K, Chow W S, Mohd Ishak Z A, Biodegradability studies of poly(butylene succinate)/organo-montmorillonite nanocomposites under controlled compost soil conditions: Effects of clay loading and compatibiliser. Polymer Degradation and Stability. 2012; 97(8), 1345-54.
[36] John J, Tang J, Yang Z, Bhattacharya M, Synthesis and characterization of anhydride-functional polycaprolactone. Journal of Polymer Science Part A: Polymer Chemistry. 1997; 35(6), 1139-48.
[37] Huneault M A, Li H, Morphology and properties of compatibilized polylactide/thermoplastic starch blends. Polymer. 2007; 48(1), 270-80.
[38] Muthuraj R, Misra M, Mohanty A K, Injection molded sustainable biocomposites from poly(butylene succinate) bioplastic and perennial grass. ACS Sustainable Chemistry and Engineering. 2015; 3(11), 2767-76
[39] Keener T J, Stuart R K, Brown T K, Maleated coupling agents for natural fibre composites. Composites Part A: Applied Science and Manufacturing. 2004; 35(3), 357-62.
[40] Carlson D, Nie L, Narayan R, Dubois P, Maleation of polylactide (PLA) by reactive extrusion. Journal of Applied Polymer Science. 1999; 72(4), 477-85.
[41] Detyothin S, Selke S E M, Narayan R, Rubino M, Auras R, Reactive functionalization of poly(lactic acid), PLA: Effects of the reactive modifier, initiator and processing conditions on the final grafted maleic anhydride content and molecular weight of PLA. Polymer Degradation and Stability. 2013; 98(12), 2697-2708.
[42] Javadi A, Srithep Y, Lee J, Pilla S, Clemonse C, Gong S, Turng L-S, Processing and characterization of solid and microcellular PHBV/PBAT blend and its RWF/nanoclay composites. Composites Part A: Applied Science and Manufacturing. 2010; 41(8), 982-90.
[43] Harnnecker F, dos Santos Rosa D, Lenz D, Biodegradable Polyester-Based Blend Reinforced with Curauá Fiber: Thermal, Mechanical and Biodegradation Behaviour. Journal of Polymers and the Environment. 2012; 20(1), 237-44.
[44] Nagarajan V, Misra M, Mohanty A K, New engineered biocomposites from poly(3-hydroxybutyrate-co-3-hydroxyvalerate) (PHBV)/poly(butylene adipate-co-terephthalate) (PBAT) blends and switchgrass: Fabrication and performance evaluation. Industrial Crops and Products. 2013; 42(0), 461-68.
[45] Yu T, Li Y, Influence of poly(butylenes adipate-co-terephthalate) on the properties of the biodegradable composites based on ramie/poly(lactic acid). Composites Part A: Applied Science and Manufacturing. 2014; 58(0), 24-9.
[46] Johnson R M, Tucker N, Barnes S, Impact performance of Miscanthus/Novamont Mater-Bi® biocomposites. Polymer Testing. 2003; 22(2), 209-15.
[47] Kirwan K, Johnson R M, Jacobs D K, Smith G F, Shepherd L, Tucker N, Enhancing properties of dissolution compounded Miscanthus giganteus reinforced polymer composite systems: Part 1. Improving flexural rigidity. Industrial Crops and Products. 2007; 26(1), 14-27.
[48] Nanda M R, Misra M, Mohanty A K, Performance Evaluation of Biofibers and Their Hybrids as Reinforcements in Bioplastic Composites. Macromolecular Materials and Engineering. 2013; 298(7), 779-88.

Through the embodiments that are illustrated and described, the currently contemplated best mode of making and using the invention is described. Without further elaboration, it is believed that one of ordinary skill in the art can, based on the description presented herein, utilize the present invention to the full extent.

Although the description above contains many specificities, these should not be construed as limiting the scope of the invention, but as merely providing illustrations of some of the presently embodiments of this invention. Thus the scope of the invention should be determined by the appended claims and their legal equivalents, rather than by the examples given.

Future applications claiming priority to this application may or may not include the following claims, and may include claims broader, narrower, or entirely different from the following claims.

1. A biodegradable composite comprising:
(a) a polymeric matrix comprising one or more biodegradable polymers;
(b) a filler, the filler selected from the group consisting of one or a combination of two or more of the following: (i) a by-product from coffee and/or tea, (ii) a perennial grass and/or agricultural residue, (iii) a co-product of grain-based ethanol industries, and (iv) an inorganic filler; and
(c) an anhydride grafted compatibilizer, the anhydride grafted compatibilizer comprising one or more biodegradable polymers modified with an anhydride group, the one or more biodegradable polymers in the compatibilizer being similar to or different from the biodegradable polymers in the polymeric matrix.

2. The biodegradable composite of claim 1, wherein the polymeric matrix includes 2 (binary), 3 (ternary) or 4 (quaternary) biodegradable polymers.

3. The biodegradable composite of claim 1, wherein the polymeric matrix includes two biodegradable polymers and the compatibilizer is a binary compatibilizer.

4. The biodegradable composite of claim 1, wherein the polymeric matrix includes three biodegradable polymers and the compatibilizer is a binary or ternary compatibilizer.

5. The biodegradable composite of claim 1, wherein the polymeric matrix includes four biodegradable polymers and the compatibilizer is a binary, ternary or quaternary compatibilizer.

6. The biodegradable composite of claim 1, wherein the biodegradable polymers are selected from the group consisting of: poly(butylene adipate-co-terephthalate) (PBAT), poly(lactic acid) (PLA), poly(butylene succinate) (PBS), poly(butylene succinate-co-adipate) (PBSA), polycaprolactone (PCL) and polyhydroxalkanoates (PHA).

7. The biodegradable composite of claim 1, wherein the biodegradable composite comprises up to 50% by weight of the filler.

8. (canceled)

9. The biodegradable composite of claim 1, wherein the filler includes the by-product of coffee and/or tea, and the by-product is one or a combination of two or more of coffee chaff, coffee husk, coffee ground, spent coffee, or spent tea leaves.

10. The biodegradable composite of claim 1, wherein the filler includes the perennial grass, and the perennial grass includes miscanthus, switchgrass and bamboo.

11. The biodegradable composite of claim 1, wherein the filler includes the agricultural residue, and the agricultural residue include straws, stalks and leaves.

12. The biodegradable composite according to claim 1, wherein the biodegradable composite further comprises (d) a polymer additive, the polymer additive being a polymer chain extender, a plasticizer or both.

13. The biodegradable composite of claim 12, wherein the polymer chain extender include glycidyl methacrylate (GMA) derived polyepoxides or a commercially available polymer chain extender, and the plasticizer includes alkyl citrates.

14. (canceled)

15. The biodegradable composite of claim 1, wherein the biodegradable composite comprises between about 0.01 and 15% by weight of the compatibilizer.

16. The biodegradable composite of claim 1, wherein the biodegradable composite comprises at least 20% by weight of biobased content.

17. The biodegradable composite of claim 1, wherein the biodegradable composite comprises at least 20% by weight of renewable materials.

18-20. (canceled)

21. The biodegradable composite according to claim 1, wherein the filler is in a pre-treated form having substantially reduced or free of odor relative the filler in an untreated form.

22. An in-situ method of manufacturing a biodegradable composite, the in-situ method comprising:
(a) melting one or more biodegradable polymers in the presence of a functional monomer and a free radical initiator to form a mixture; and
(b) adding a filler to the mixture, the filler selected from the group consisting of one or a combination of two or more of the following: (i) a by-product from coffee, tea or both, (ii) a perennial grass and/or agricultural residue, (iii) a co-product of grain-based ethanol industries, and (iv) and inorganic filler.

23. The method of claim 22, wherein step (a) comprises melting two, three or four biodegradable polymers.

24-25. (canceled)

26. A method of manufacturing a biodegradable composite, the method comprising:
(a) synthesizing a compatibilizer by (i) mixing a free radical initiator and a functional monomer, (ii) melting one or more biodegradable polymers to form a melt, and (iii) combining the product of step (i) and the melt of step (ii) thereby synthesizing the compatibilizer; and
(b) mixing the compatibilizer of step (a), with a matrix of biodegradable polymers and one or more fillers, thereby manufacturing the biodegradable composite, the one or more biodegradable polymers in the melt being similar to or different from biodegradable polymers in the matrix.

27. The method of claim 26, wherein the melt includes a number of biodegradable polymers that is more than the number of biodegradable polymers in the matrix.

28. The method of claim 26, wherein the melt includes a number of biodegradable polymers that is equal to the number of biodegradable polymers in the matrix.

29. The method of claim 26, wherein the melt includes a number of biodegradable polymers that is less than the number of biodegradable polymers in the matrix.

30-33. (canceled)

34. The method of claim 22, wherein the biodegradable polymers are selected from the group consisting of: poly(butylene adipate-co-terephthalate) (PBAT), poly(lactic acid) (PLA), poly(butylene succinate) (PBS), poly(butylene succinate-co-adipate) (PBSA), polycaprolactone (PCL) and polyhydroxalkanoates (PHA), the functional monomer is maleic anhydride or a structural analogue or derivative thereof, and the free radical initiator is selected from benzoyl peroxide and dicumyl peroxide.

35-36. (canceled)

37. The method of claim 22, wherein the method further comprises adding a polymer additive wherein the polymer additive is selected from a polymer chain extender or a plasticizer or both.

38. The method of claim 37, wherein the polymer chain extender is selected from glycidyl methacrylate (GMA) derived polyepoxides, and the plasticizer is selected from alkyl citrates.

39. (canceled)

40. The method of claim 22, wherein the filler is provided in a pre-treated form having substantially reduced or free of odor relative the filler in an untreated form.

41. The biodegradable composite of claim 22, wherein the filler includes the by-product of coffee and tea, and the by-product is one or a combination of two or more of coffee chaff, coffee husk, coffee ground, spent coffee, or spent tea leaves.

42. The biodegradable composite of claim 22, wherein the filler includes the perennial grass, and the perennial grass includes miscanthus, switchgrass and bamboo.

43. The biodegradable composite of claim 22, wherein the filler includes the agricultural residue, and the agricultural residue includes straws, stalks and leaves.

44. The biodegradable composite of claim 22, wherein the filler includes the co-product of grain-based ethanol industries, and the co-product of grain-based ethanol industries includes dried grains (DDG), distillers' dried grains with solubles (DDGS), gluten meals, kernel fibre and gluten feeds.

45. The biodegradable composite of claim 22, wherein the filler is the inorganic filler, wherein the inorganic filler includes talc, clay, calcium carbonate, wollastonite, and barium sulfate.

46. The biodegradable composite of claim 1, wherein the filler includes the co-product of grain-based ethanol industries, wherein the co-product of grain-based ethanol industries is selected from the group consisting of: dried grains (DDG), distillers' dried grains with solubles (DDGS), gluten meals, kernel fibre and gluten feeds.

47. The biodegradable composite of claim 1, wherein the filler is the inorganic filler, wherein the inorganic filler is selected from the group consisting of: talc, clay, calcium carbonate, wollastonite, and barium sulfate.
